(19) United States
(12) Patent Application Publication
(10) Pub. No.: US 2015/0041388 A1
(43) Pub. Date: Feb. 12, 2015

(54) SEPARATION MEMBRANE AND SEPARATION MEMBRANE ELEMENT

(71) Applicant: Toray Industries, Inc., Tokyo (JP)

(72) Inventors: Hiroho Hirozawa, Otsu-shi (JP); Masakazu Koiwa, Otsu-shi (JP); Hiroyuki Yamada, Otsu-shi (JP); Kentaro Takagi, Otsu-shi (JP); Yoshiki Okamoto, Otsu-shi (JP); Tsuyoshi Hamada, Otsu-shi (JP); Katsufumi Oto, Otsu-shi (JP); Masahiro Kimura, Otsu-shi (JP)

(21) Appl. No.: 14/379,504

(22) PCT Filed: Feb. 19, 2013
(86) PCT No.: PCT/JP2013/053933

§ 371 Date: Aug. 19, 2014

(30) Foreign Application Priority Data
Feb. 24, 2012 (JP) 2012-038521
Jun. 28, 2012 (JP) 2012-145158

(51) Int. Cl. B01D 71/80; B01D 67/00; B01D 71/68; B01D 69/04

(52) U.S. Cl. CPC B01D 71/80; B01D 69/04; B01D 67/0088; B01D 71/68; B01D 2325/02; B01D 2325/06
USPC 210/457; 210/483

(57) ABSTRACT

A separation membrane includes a separation membrane main body that includes a supply-side surface and a filtrate-side surface; and a supply-side channel member disposed on the supply-side surface of the separation membrane main body, wherein when a thickness of the supply-side channel member in a direction perpendicular to a flowing direction of a supplied water that flows on the supply-side surface is a width d of the supply-side channel member, a ratio of height/width (h/d) of the supply-side channel member is 0.7 or greater and 3.0 or less.

### TECHNICAL FIELD

This disclosure relates to a separation membrane element for use in separating components contained in a fluid such as a liquid, a gas and the like.

### BACKGROUND

There are a variety of methods of separating components contained in a fluid such as a liquid or a gas. Take, for example, a technology that removes ionic substances contained in seawater, saline water or the like. In recent years, separation methods based on separation membrane elements are increasingly being used as processes to save energy and resources. The separation membranes used in the separation methods based on separation membrane elements vary in view of pore size and separation function thereof such as microfiltration membranes, ultrafiltration membranes, nanofiltration membranes, reverse osmosis membranes, forward osmosis membranes and the like. These membranes are used, for example, in the case of obtaining drinking water from seawater, saline water, water containing a harmful material and the like, or for production of industrial ultrapure water, drainage water processes, recovery of valuable materials and the like. The membranes are selectively used according to the target components to be separated and separation performance.

The separation membrane elements have a common feature that a raw fluid is fed to one surface of a separation membrane and a filtrate is obtained from the other surface thereof. A separation membrane element is constructed by bundling many separation membrane devices of various shapes so that the membrane area is increased and a large amount of filtrate can be obtained per unit element. Various elements such as a spiral type, a hollow fiber type, a plate-and-frame type, a rotary flat membrane type, a flat-membrane integrated type and the like are produced in accordance with uses and purposes.

Take, for example, a fluid separation membrane element for use for reverse osmosis filtration. As for a separation membrane element member thereof, a spiral type separation membrane element is widely used in view of application of pressure to the raw fluid and extraction of a large amount of filtrate. In the spiral type separation membrane element members made up of a supply-side channel member that feeds a raw fluid to a separation membrane surface, a separation membrane that separates components contained in the raw fluid, and a filtrate-side channel member for leading to a water collecting pipe the filtrate-side fluid having passed through the separation membrane and therefore having been separated from the supply-side fluid are wrapped around the water collecting pipe.

For example, members of the spiral type reverse osmosis separation membrane element are as follows. As for the supply-side channel member, a net made of a macromolecular material is mainly used to form channels for the supply-side fluid. As the separation membrane, a separation membrane in which a separation function layer made up of a crosslinked macromolecular material such as polyamide, a porous resin layer made of a macromolecular material such as polysulfone, and a nonwoven fabric made of a macromolecular material such as polyethylene terephthalate, are individually layered from the supply side to the filtrate-side is used. As for the filtrate-side channel member, a knitted member called tricot that has smaller intervals than the supply-side channel member is used for the purpose of preventing fall of the membrane and forming filtrate-side channels.

In recent years, as for the separation membrane elements, due to increased demand for reduction of the water production cost, the need to improve the performance of the membrane element has been demanded. In conjunction with increasing the separation performance of the separation membrane element and the amount of filtrate produced per unit time, improvements in the performances of each channel member and a separation membrane element member have been proposed. For example, Japanese Unexamined Patent Publication (Kokai) No. 2012-40487 discloses a spiral type separation membrane module that has a spiral type membrane element in which flat membranes each provided with a plurality of dots formed in a certain direction on an obverse surface or both surfaces of a flat membrane are layered, and are wound around an outer periphery of a water collecting pipe in a spiral form.

However, as for the separation membrane element mentioned above, the stability of separation removal performance cannot be said to be sufficiently high.

Accordingly, it could be helpful to provide a separation membrane and a separation membrane element in which the separation removal performance when the separation membrane element is operated with high pressure applied in particular can be stabilized.

### SUMMARY

We provide separation membranes comprising: a separation membrane main body that includes a supply-side surface and a filtrate-side surface; and a supply-side channel member disposed on the supply-side surface of the separation membrane main body, wherein when a thickness of the supply-side channel member in a direction perpendicular to a flowing direction of a supplied water that flows on the supply-side surface is a width of the supply-side channel member, a ratio of height/width of the supply-side channel member is 0.7 or greater and 3.0 or less.

In the separation membrane and the separation membrane element that uses this separation membrane, stable supply-side channels can be formed so that the separation performance of the separation membrane element and the amount of filtrate per unit time can be improved and the separation removal performance thereof can be stabilized.

### BRIEF DESCRIPTION OF THE DRAWINGS

FIGS. 1 (a) and (b) are illustrative diagrams schematically illustrating a portion of the separation membrane, and FIG. 1(a) is a plan view, and FIG. 1(b) is a side view.

FIG. 2 is a plan view schematically illustrating an arrangement pattern of supply-side channel members that constitute our separation membrane.

FIG. 3 is a plan view schematically illustrating another arrangement pattern of the supply-side channel members that constitute our separation membrane.

FIG. 4 is an illustrative diagram showing the arrangement pattern presented in FIG. 2 in an enlarged view.

FIG. 5 is an illustrative diagram showing the arrangement present in FIG. 3 in an enlarged view.

FIG. 6 is a perspective view in which an example of the separation membrane element is partially developed.

FIG. 7 is a developed perspective view schematically illustrating an example of the separation membrane that constitutes the separation membrane element.

### EXPLANATION OF NUMERALS

1: separation membrane element
2: water collecting pipe
21: upstream-side end portion of the separation membrane element
22: downstream-side end portion of the separation membrane element
3: separation membrane
30: separation membrane main body
31: separation membrane supply-side surface
32: separation membrane filtrate-side surface
33, 34: band-shaped region
4, 4a-4g: first supply-side channel member
42: second supply-side channel member
5: filtrate-side channel member
6: envelope-shaped membrane
7: upstream-side end plate
8: downstream-side end plate
101: supplied water
102: filtrate
103: concentrated water
W0: width of the separation membrane in the water collecting pipe lengthwise direction
W1, W2: width of band-shaped region in the same direction

### DETAILED DESCRIPTION

Herein, an example will be described in detail below.

### 1. Separation Membrane

### (1-1) Summary

The separation membrane is a membrane capable of separating components contained in a fluid (supplied water) fed to a separation membrane surface and obtaining a permeate fluid that has permeated through the separation membrane. The separation membrane includes a separation membrane main body and a supply-side channel member disposed on the separation membrane main body.

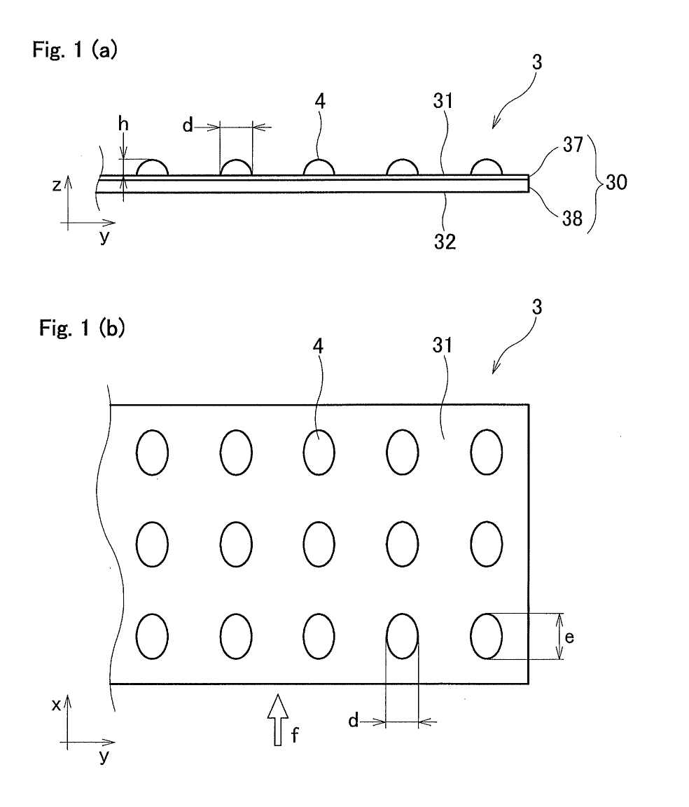

As an example of such a separation membrane, there is shown as an example in FIGS. 1 (a) and (b), and will be described. FIGS. 1 (a) and (b) indicate relationships among the shapes, the dimensions and the positions of a separation membrane 30 and supply-side channel members 4 in simplified and partially enlarged views, to facilitate the understanding of the example. The separation membrane is not restricted by this example.

As shown in FIGS. 1 (a) and (b), the separation membrane 3 includes a separation membrane main body 30 and the supply-side channel members 4. The separation membrane main body 30 includes a supply-side surface 31 and a filtrate-side surface 32. The supply-side channel members 4 are disposed on the supply-side surface 31 of the separation membrane main body 30.

In this description, the “supply-side surface” of the separation membrane main body means a surface on the side where a raw fluid (supplied water) is fed, of two surfaces of the separation membrane main body. The “filtrate-side surface” means a surface on the opposite side. When the separation membrane main body 30 includes a base material 38 and a separation function layer 37, generally, the surface on the separation function layer 37 side is the supply-side surface 31, and the surface on the base material 38 side is the filtrate-side surface 32.

In the drawings, direction axes that are an x-axis, a y-axis and a z-axis for the separation membrane are shown. The x-axis is sometimes referred to as a width direction (CD) of the separation membrane, and the y-axis is sometimes referred to as a longitudinal direction (MD) of the separation membrane. The z-axis is in a thickness direction of the separation membrane. The separation membrane main body 30 is a rectangle in shape, the width direction (CD) and the longitudinal direction (MD) are parallel to an outside edge of the separation membrane main body 30. In the example shown in FIG. 1 (b), the supplied water introduced onto the supply-side surface 31 of the separation membrane flows in a direction indicated by an arrow f.

### (1-2) Separation Membrane Main Body

### Summary

As the separation membrane main body 30, a membrane having a separation performance commensurate with the method of use, the purpose or the like is used. The separation membrane main body 30 may be formed by a single layer, or may also be a composite membrane that includes the separation function layer 37 and the base material 38. In the composite membrane, a porous support layer may be formed between the separation function layer and the base material.

### Separation Function Layer

Although the thickness of the separation function layer is not limited to a concrete numerical value, the thickness is preferred to be 5 to 3000 nm in view of separation performance and permeation performance. In particular, in reverse osmosis membranes, forward osmosis membranes and nanofiltration membranes, the thickness of the separation function layer is preferred to be 5 to 300 nm.

A measurement method of thickness of the separation function layer may be in conformance with an ordinary membrane thickness measurement method for separation membranes. For example, a separation membrane is embedded in resin, and then made into ultrathin slices by cutting, and the obtained slices are treated with staining or the like. After that, observation is performed under a transmission electron microscope so that measurement of the thickness can be performed. When a separation function layer has a pleats structure, the thickness of the separation function layer can be found by measuring the thickness of the pleats structure located above the porous support layer, at intervals of 50 nm in the longitudinal direction (MD) of the cross-section of the pleats structure, performing such measurement with respect to 20 pleats, and then obtaining an average of the measured thicknesses.

The separation function layer may be a layer having both the separation function and a support function, or may also have only the separation function. “Separation function layer” refers to a layer that has at least the separation function.

When the separation function layer has both the separation function and the support function, what is preferably applied as the separation function layer is a layer that contains cellulose, polyvinylidene fluoride, polyether sulfone or polysulfone as a main component.

-“X contains Y as a main component” means that the content rate of Y in X is 50 mass % or greater, 70 mass % or greater, 80 mass % or greater, 90 mass % or greater, or 95 mass % or greater. When a plurality of components that correspond to Y exist, it suffices that the total amount of the plurality of components be in a range as mentioned above.

On another hand, as for the separation function layer, a crosslinked macromolecular material is preferably used in view of easy control of pore size and excellent durability. In particular, in view of excellent separation performance for components in a raw fluid, an organic-inorganic hybrid function layer, a polyamide separation function layer formed by polycondensation of a multifunctional amine and a multifunctional acid halide or the like are suitably used. These separation function layers can be formed by polycondensation of monomers on the porous support layer.

For example, the separation function layer can contain polyamide as a main component. Such a membrane is formed by interfacial polycondensation of a multifunctional amine and a multifunctional acid halide according to a known method. For example, a polyamide separation function layer can be obtained by applying a multifunctional amine aqueous solution to a porous support layer, and removing a surplus amount of the amine aqueous solution by air knife or the like, and then applying an organic solvent solution containing a multifunctional acid halide.

The separation function layer may have an organic-inorganic hybrid structure that has Si element or the like. The separation function layer having an organic-inorganic hybrid structure can contain, for example, compounds (A) and (B) as follows:
(A) a silicon compound in which a hydrolyzable group and a reactive group having an ethylenically unsaturated group are directly bonded to a silicon atom; and
(B) a compound that is other than the compound (A) and that has an ethylenically unsaturated group.
   Concretely, the separation function layer may contain a condensate of the hydrolyzable group of the compound (A) and a polymeric substance of the ethylenically unsaturated group of the compound (A) and/or (B). That is, the separation function layer can contain at least one species of polymeric substance of:
a polymeric substance formed by condensation and/or polymerization of only the compound (A);
a polymeric substance formed by polymerization of only the compound (B); and
a copolymeric substance of the compound (A) and the compound (B).
   Polymeric substance includes condensate. In a copolymeric substance of the compound (A) and the compound (B), the compound (A) may be condensed via the hydrolyzable group.

The hybrid structure can be formed by a known method. An example of the formation method for the hybrid structure is as follows. A reaction liquid containing the compound (A) and the compound (B) is applied to the porous support layer. After a surplus amount of the reaction liquid is removed, it suffices that a heating process is carried out to condensate the hydrolyzable group. As a polymerization method for the ethylenically unsaturated groups of the compound (A) and the compound (B), it suffices that a heating process, electromagnetic wave irradiation, electron beam irradiation or plasma irradiation is carried out. For the purpose of increasing the polymerization velocity, a polymerization initiator, a polymerization accelerator and the like can be added at the time of formation of the separation function layer.

In any separation function layer, a surface of the membrane may be hydrophilized by, for example, an alcohol-containing aqueous solution or an alkali aqueous solution, before being used.

### Porous Support Layer

The porous support layer is a layer that supports the separation function layer, and can be paraphrased into a porous resin layer.

The material that is used for the porous support layer and the shape of the layer are not particularly limited; however, for example, the porous support layer may be formed on a substrate from a porous resin. As the porous support layer, polysulfone, cellulose acetate, polyvinyl chloride, epoxy resin, or a layered or mixed body thereof is used, and it is preferable to use polysulfone, which is high in chemical, mechanical and thermal stability and whose pore size is easy to control.

The porous support layer gives a mechanical strength to the separation membrane, and does not have a separation performance for components small in molecular size such as ions, unlike the separation membrane. The size of pores that the porous support layer has and the distribution of the pores are not particularly limited. However, for example, the porous support layer may have uniform and small pores, or may have a distribution of pore size such that the diameters gradually become larger from the surface of the side where the separation function layer is formed toward the other surface. In any case, the projected area equivalent circle diameter of fine pores measured on the surface of the side where the separation function layer is formed, through the use of an atomic force microscope, an electron microscope and the like, is preferred to be 1 nm or greater and 100 nm or less. In particular, in view of interfacial polymerization reactivity and retainability of the separation function layer, the pores on the surface of the side of the porous support layer on which the separation function layer is formed are preferred to have a projected area equivalent circle diameter of 3 to 50 nm.

The thickness of the porous support layer is not particularly limited. However, for the reason for giving strength to the separation membrane, or the like, the thickness is preferred to be in the range of 20 μm or greater and 500 μm or less, and more preferably 30 μm or greater and 300 μm or less.

The configuration of the porous support layer can be observed under a scanning electron microscope, a transmission electron microscope, an atomic force microscope. For example, if an observation is made under a scanning electron microscope, the porous support layer is peeled from the base material and then is cut by a freeze fracture method to obtain samples for cross-section observation. This sample is thinly coated with platinum, or platinum-palladium or ruthenium tetrachloride and, preferably, with ruthenium tetrachloride, and is observed under a high-resolution electric field radiation type scanning electron microscope (UHR-FE-SEM), with an acceleration voltage of 3 to 6 kV. As for the high-resolution electric field radiation type scanning electron microscope, an S-900 type electron microscope manufactured by Hitachi or the like can be used. The membrane thickness of the porous support layer and the projected area equivalent circle diameter of the surface can be measured on the basis of an electron microscopic picture obtained.

The thickness and the pore size of the porous support layer are average values. As for the thickness of the porous support layer, measurement is performed at intervals of 20 μm in a direction orthogonal to the thickness direction in the cross-section observation, and an average value of the measurements obtained at the 20 points is adopted. The pore size is an average value of the projected area equivalent circle diameters measured with respect to 200 pores.

Next, the formation method for the porous support layer will be described. The porous support layer can be produced, for example, by pouring an N,N-dimethyl formamide (hereinafter, termed DMF) solution of polysulfone mentioned above, using a die, to a constant thickness over a base material described below, for example, a tightly-woven polyester cloth or a nonwoven fabric, and then wet-solidifying the poured material in water.

The porous support layer is formed according to a method mentioned in “Office of Saline Water Research and Development Progress Report” No. 359 (1968). The polymer concentration, the temperature of the solvent and the poor solvent can be adjusted to obtain a desired configuration.

For example, a predetermined amount of polysulfone is dissolved in DMF to prepare a polysulfone resin solution of a predetermined concentration. Next, this polysulfone resin solution is applied to a substantially constant thickness on a base material made of a polyester cloth or nonwoven fabric. Then, after the solvent on the surface is removed in air for a certain time, polysulfone is coagulated in the congealed liquid, whereby the porous support layer can be obtained.

### Base Material

From the viewpoint of strength and dimensional stability of the separation membrane main body 30 and the like, the separation membrane main body 30 may have a base material. As the base material, it is preferable to use a fibrous base in view of strength, an irregularity forming performance and fluid permeability.

As the base material, either one of long-fiber nonwoven fabric and short-fiber nonwoven fabric can be preferably used. In particular, the long-fiber nonwoven fabric, having excellent membrane formation property, can considerably prevent incidents where when a solution of a macromolecular polymer is flow-cast, the solution passes through to the other side due to excessive penetration, and where the porous support layer peels off, and where the membrane becomes non-uniform due to the fuzzing of the base material and the like, and where a defect such as a pinhole, occurs. Since the base material is made of a long-fiber nonwoven fabric that is constructed of thermoplastic continuous filaments, the incidence of a membrane defect and non-uniformity caused by the fluffing of fiber during a macromolecular solution casting can be reduced in comparison with a short-fiber nonwoven fabric. Furthermore, since the separation membrane, during a continuous membrane formation, is subjected to tension in the membrane formation direction, a long-fiber nonwoven fabric excellent in dimensional stability is preferred to be used as a base material.

As for the long-fiber nonwoven fabric, in view of formability and strength, it is preferred that the fiber in a surface layer on an opposite side to the porous support layer be more longitudinally oriented than the fiber in a surface layer on the porous support layer side. According to such a structure, the retainment of strength achieves a good effect of preventing membrane breakage and the like. Moreover, the formability as a laminate including the porous support layer and the base material, at the time of providing the separation membrane with irregularities, improves so that the shape of the irregularities of the surface of the separation membrane stabilizes. Thus, this structure is preferable.

More concretely, the fiber orientation degree in the surface layer of the long-fiber nonwoven fabric which is on the opposite side to the porous support layer is preferred to be 0° to 25°, and the difference of the orientation degree thereof from the fiber orientation degree in the porous support layer-side surface layer is preferred to be 10° to 90°.

The production process of the separation membrane and the production process of the element include a step of heating. Heating causes a phenomenon in which the porous support layer or the separation function layer shrinks. Particularly in the width direction (CD) in which tension is not applied during the continuous membrane formation, the shrinkage is conspicuous. Since shrinkage causes problems in dimensional stability and the like, the base material is desired to be a base material of which the rate of thermal dimensional change is small. If in the nonwoven fabric, the difference between the fiber orientation degree of the surface layer on the opposite side to the porous support layer and the fiber orientation degree of the porous support layer-side surface layer is 10° to 90°, the change in the width direction (CD) due to heat can be depressed, which is preferable.

The fiber orientation degree is an index that indicates the orientation of fiber of the nonwoven fabric base material that constitutes the porous support layer. Concretely, the fiber orientation degree is an average value of the angle between the membrane formation direction when the continuous membrane formation is performed, that is, the lengthwise direction (MD) of the nonwoven fabric base material, and the fiber that constitutes the nonwoven fabric base material. That is, if the lengthwise direction (MD) of the fiber is parallel with the membrane formation direction, the fiber orientation degree is 0°. If the lengthwise direction (MD) of the fiber is at right angle to the membrane formation direction, that is, if it is parallel with the width direction (CD) of the nonwoven fabric base material, the orientation degree of the fiber is 90°. Hence, the closer to 0° the fiber orientation degree is, the more longitudinal the orientation is. The closer to 90° the fiber orientation degree, the more lateral the orientation.

The fiber orientation degree is measured as follows. Firstly, 10 small-piece samples are randomly picked up from the nonwoven fabric. Next, the surface of each sample is photographed by a scanning electron microscope at a magnification of 100 to 1000 times. In the photographed image, 10 fibers are selected from each sample, and the angles of the fibers are measured with reference to the lengthwise direction of the nonwoven fabric (the longitudinal direction, the membrane formation direction) being assumed to be 0°. That is, measurement of the angle is performed with regard to a total of 100 fibers for each nonwoven fabric. From the angles with respect to the 100 fibers thus measured, an average value is calculated. A value obtained by rounding the obtained average value to unit is a fiber orientation degree.

The thickness of the base material is preferred to be set to be approximately within the range of 30 to 300 μm or within the range of 50 to 250 μm.

### (1-3) Supply-Side Channel Member

### Ratio of Height/Width

As an example of the supply-side channel member, the supply-side channel members 4, as shown in FIGS. 1 (a) and (b), are disposed on the supply-side surface 31 of the separation membrane main body 30. Preferably, it is appropriate that the supply-side channel members 4 be fixed onto the supply-side surface 31 of the separation membrane main body 30.

The ratio (h/d) between the height h and the width d of the supply-side channel members 4 is 0.7 or greater and 3.0 or less. By disposing the supply-side channel members 4 mentioned above, the projected area of the channel member per unit can be reduced in comparison with when the related-art net or dot is used as a channel member. Therefore, even if the number of the supply-side channel members 4 is increased, it is possible to disturb the flow of the supplied water so that the effect of restraining the salt concentration polarization is increased, while reducing the resistance in the supply-side channel.

There is a tendency that as the ratio between the height h and the width d of the supply-side channel members 4, that is, the ratio of height/width (h/d), becomes greater, the width d of the supply-side channel members 4 becomes narrower and, therefore, the flow resistance decreases. However, if the ratio (h/d) is excessively large, the supply-side channel members 4 become likely to peel off from the separation membrane main body 30 due to the shearing of the supplied water at the time of pressure filtration. If the channel member peels from the separation membrane main body, the separation function layer is lost so that favorable separation performance cannot be obtained.

Conversely, as the ratio (h/d) becomes smaller, the height d of the supply-side channel members 4 becomes smaller or the width d of the supply-side channel members 4 becomes greater so that the channel becomes narrower and the flow resistance becomes greater. When the separation membrane is rolled around the perimeter of a water collecting pipe and is bent in the length direction (MD), there is a tendency that it becomes more difficult for the supply-side channel members 4 to follow the expansion and contraction of the supply-side surface 31 of the separation membrane and it is more likely that breakage will occur. Furthermore, during a long-time operation or when the pressure filtration and the stop are repeated, the supply-side channel members 4 become more easily breakable so that the supply-side channel will be obstructed and the amount of water obtained by pressure filtration will lessen.

Hence, the ratio (h/d) between the height h and the width d of the supply-side channel members 4 is set to 0.7 or greater and 3.0 or less. Preferably, it is appropriate to set the ratio (h/d) to 1.5 or greater and 2.0 or less.

The “height h” can be paraphrased into the “thickness” of the supply-side channel members 4 in the z-axis direction, and is measured as an elevation difference between the surface of the supply-side surface 31 of the separation membrane main body 30 and top portions of the supply-side channel members 4.

Furthermore, the “width” is the width of the supply-side channel members 4 in a direction perpendicular to the flowing direction of supplied water that flows on the supply-side surface 31. The length of the supply-side channel members 4 in the flowing direction of supplied water flowing on the supply-side surface 31 is termed “length e.” For example, in an example as shown in FIG. 1 (b) where the supply-side channel members 4 are cylinders with elliptical bottoms, and are arranged so that the long diameters thereof are parallel with a supplied water flowing direction (x-axis direction) indicated by an arrow f, the width of the supply-side channel members 4 is such that the short diameter in the y-axis direction is the width d. If the supply-side channel members 4 have a linear rectangular parallelepiped shape (bottom surfaces has a linear shape) extending in the x-axis direction, the breadth thereof in the y-axis direction corresponds to the width d.

Since the plurality of supply-side channel members 4 are provided discontinuously from one another, the amount of channel members is less than in nets that are typical supply-side channel members. As a result, portions where foulants in supplied water deposit lessen. Furthermore, in comparison with the related-art dots mentioned in JP '487, the effect of disturbing the flow of supplied water is great so that foulants less easily deposit on the channel members. For these reasons, the supply-side channel members 4 can restrain the fouling at the supply side in comparison with the related-art channel members.

### Projected Area Ratio

In view of reducing the flow resistance at the supply-side surface side and causing the channel to stably form in conjunction with arrangement of the supply-side channel members 4 on the supply-side surface 31 of the separation membrane main body 30, the projected area ratio of the supply-side channel members (including second supply-side channel members 42 described later) is preferred to be 0.05 or greater and 0.6 or less and, more preferably, 0.1 or greater and 0.5 or less.

The projected area ratio of the supply-side channel members is a value obtained by cutting a separation membrane main body on which supply-side channel members are disposed into 5 cm×5 cm and dividing by the cut-out area (25 cm²) the projected area obtained when the supply-side channel members are projected from above the separation membrane surface onto a supply-side surface through the use of a commercially available microscopic image analysis apparatus.

By disposing the supply-side channel members on the supply-side surface of the separation membrane main body at a specific projected area ratio, it becomes possible to not only stably form a supply-side channel when the separation membrane main body is given pressure as an element but also form a high-efficient channel that is smaller in flow resistance than in the related-art nets. It is preferred that the supply-side channel member and the separation membrane main body be adhered. In that case, the function membrane surface is less likely to be damaged at the time of occurrence of rapid pressure fluctuations, flow fluctuations and the like and, therefore, is excellent in durability, in comparison with the case when a continuous body such as a related-art net or the like, is used and is not adhered to the membrane. Hence, movement on the membrane surface of the supply-side channel members is less, and the damaging of the membrane can be prevented, and stable operation can be attained, in comparison with a channel member such as a related-art net.

### Elevation Difference

The height h (elevation difference) of the supply-side channel members is determined by taking into account the number of membrane leaves that fill the separation membrane element, and the flow resistance. If the elevation difference is excessively low, the flow resistance of the channel becomes large, and the separation characteristic and the water permeation performance decline. If the height h is excessively high, the flow resistance becomes small, but the number of membrane leaves becomes small when in an element. Then, the water production capability of the element declines, and the operation cost for increasing the amount of water production becomes high. Therefore, considering the balance of the aforementioned various performances and the operation cost, the height h (elevation difference) is preferred to be 0.1 mm or greater and 2 mm or less, and more preferably 0.3 mm or greater and 1 mm or less.

A leaf is a set of two separation membranes cut out into a length suitable for incorporation into the element, or a separation membrane that is folded back in the longitudinal direction (MD) of the separation membrane so that the filtrate-side surface is inside and the supply-side surface is outside. In examples of the separation membrane element described below, leaves are arranged so that the supply-side surfaces of the separation membranes of two adjacent leaves face each other.

The height h of the supply-side channel members 4 can be measured by using a commercially available shape measurement system or the like. For example, the measurement can be carried out by the thickness measurement from a cross-section through the use of a laser microscope, a high accuracy shape measurement system KS-1100 manufactured by Keyence or the like. The measurement is performed at arbitrary sites where a supply-side channel member is present, and the height h can be found by dividing the value obtained by summing the values of the individual heights by the total number of measurement sites.

### Width D, Aspect Ratio and Pitch

For the same reason with the height h (elevation difference), the width d of the supply-side channel member is preferred to be 0.1 mm or greater and 30 mm or less, and more preferably 0.2 mm or greater and 10 mm or less. The aspect ratio at the time of observation from above the separation membrane surface is 1 or greater and 20 or less. The aspect ratio (d/e) is a value obtained by dividing the width d of the supply-side channel members 4 by the length e thereof.

It is appropriate that the pitches between the supply-side channel members 4 be designed as appropriate between one tenth to 50 times the width d or the length e. The pitch means a horizontal distance between the highest point on a channel member and the highest point on another channel member adjacent to the channel member.

### Shape

The shape of the supply-side channel members 4 on the entire separation membrane may be a discontinuous shape such as dots, a continuous shape such as a linear shape, a net configuration, and is not particularly limited. However, the shape is preferred to be a discontinuous shape to lessen the flow resistance.

In a discontinuous shape, the shape of each channel member is not particularly limited, and can be changed so that the flow resistance of the channel is reduced and so that the channel in conjunction with supply of raw fluid to the separation membrane and permeation through the separation membrane is stabilized. For example, the planar shape of the supply-side channel members 4 (the shape observed from above the surface of the separation membrane) may be an ellipse, a circle, an oval, a trapezoid, a triangle, a rectangle, a square, a parallelogram, a rhombus or an indefinite shape. Stereoscopically, what are applied are, for example, a shape in which the width of the channel member is constant, a shape in which the width increases or, conversely, the width decreases with approach to the surface of the separation membrane main body, in a cross-section of the separation membrane perpendicular to a membrane surface direction.

### Pattern

The pattern in which the supply-side channel members 4 are disposed on the supply-side surface 31 is not particularly limited as long as the pattern secures a channel. Patterns such as a so-called “grid” shape, a “zigzag” shape or the like can be used according to purpose, and combinations thereof may also be used. The zigzag shape makes it possible to uniformly feed raw fluid to the separation membrane, and is therefore preferable. If the raw fluid can be uniformly supplied to the separation membrane, the flow-disturbing effect (agitating effect) on a membrane surface becomes greater. This makes it possible to restrain the decline in the separation performance due to concentration polarization or the like.

When the separation membrane is rolled around the perimeter of the water collecting pipe and thus a separation membrane element is formed, leaves are fabricated by folding or adhering the separation membrane to form pairs with the supply-side surface of the separation membrane being disposed outside. At this time, supply-side channel members may be disposed only on the surface of one separation membrane of the membranes that form a leaf, or supply-side channel members may also be disposed on both of the separation membranes that form a leave. Furthermore, the supply-side channel members 4 fixed to two separation membranes may be disposed as desired.

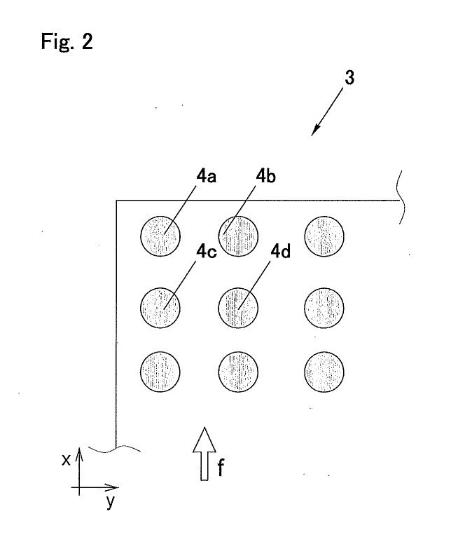

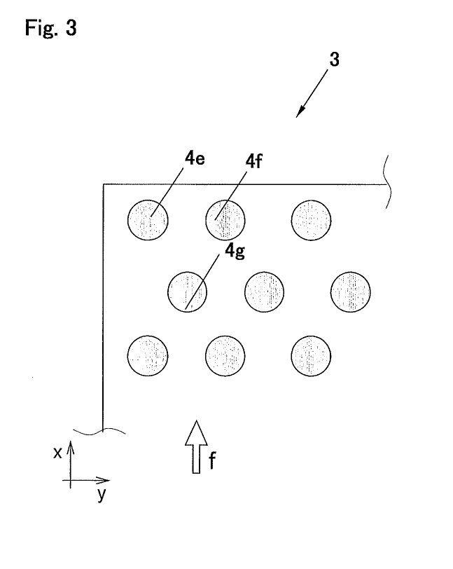

The grid shape means a manner in which, as in the separation membrane 3 illustrated in FIG. 2, the supply-side channel members 4 are formed at constant pitches in at least two nearly orthogonal directions (the x-axis direction and the y-axis direction) so that four adjacent supply-side channel members 4a, 4b, 4c, 4d form a roughly square shape. The zigzag shape means a manner in which, as in the separation membrane 3 illustrated in FIG. 3, the supply-side channel members 4 are formed at constant pitches in at least three directions so that three adjacent sup-ply-side channel members 4e, 4f, 4g form the vertexes of a roughly equilateral triangular shape.

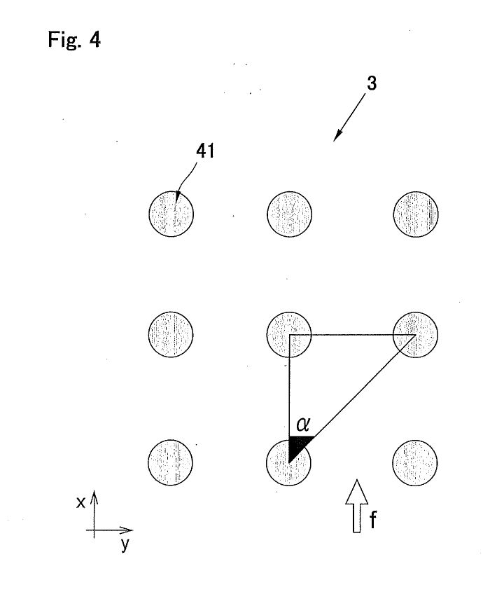

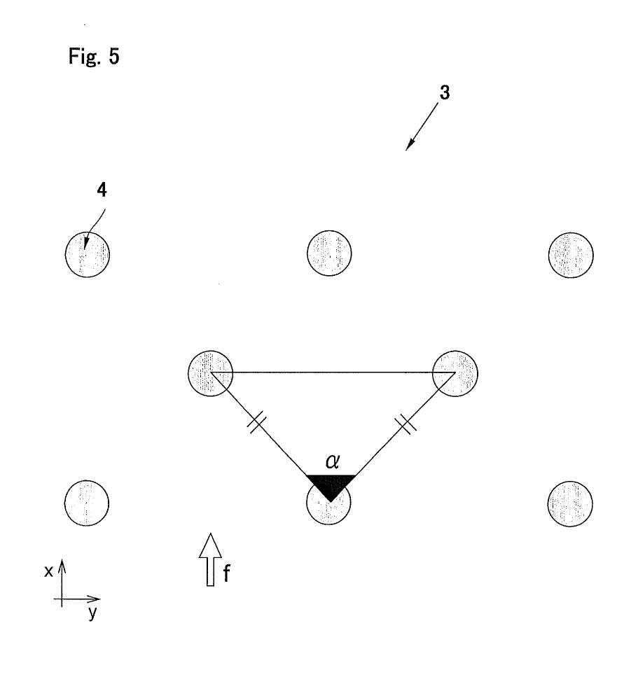

Concretely, the angle between a supply-side channel member 4 and an adjacent supply-side channel member 4 is preferred to be 20 to 160°, and more preferably 35 to 80°. When all the supply-side channel members 4 have equal pitches, the angles is 45° as in FIG. 4 if the supply-side channel members 4 are in the grid shape, and the angel is 90° if the supply-side channel members 4 are in the zigzag shape as in FIG. 5. “Adjacent” indicates that a supply-side channel member 4 that serves as a reference has the smallest or the second smallest pitch to other supply-side channel members 4 present in the flowing direction of supplied water (the direction indicated by an arrow f in the drawings, and the direction from a supplied water inlet opening side to an outlet opening side). However, when two smallest pitches exist as in the case of the zigzag shape in FIG. 5, the “adjacent” refers to each of the two pitches. There also exist cases where distances between two adjacent supply-side channel members 4 are equal.

### Steps

Although the step of disposing supply-side channel members is not particularly limited, it is possible to preferably adopt a step of processing a support membrane in a stage prior to manufacturing the separation membrane, a step of processing the porous support layer, a step of processing the base material, a step of processing a laminate formed by laminating the porous support layer and the base material, and a step of processing the separation membrane in which the separation function layer has been formed.

### Disposing Method

Although the method of disposing the supply-side channel member on the supply-side surface of the separation membrane is not particularly limited, methods such as a nozzle-type hot melt applicator, a spraying-type hot melt applicator, a flat nozzle-type hot melt applicator, a roll-type coater, a gravure method, an extrusion-type coater, printing, spraying and the like are used.

For example, when the supply-side channel members are disposed by hot melt processing, the shape of the supply-side channel member can be freely adjusted so that required conditions regarding the separation characteristic and the permeation performance can be satisfied, by changing the process temperature and the kind of the resin for hot melt to be selected. Then, it suffices that the supply-side channel members are applied again so that the ratio (h/d) of between the height h and the width d of the supply-side channel members is 0.7 or greater and 3.0 or less.

For example, if the material of the supply-side channel members is applied to the separation membrane main body 30, and if after the material hardens, the material of the channel members is applied on the hardened material, the applied layers melt to achieve firm adhesion. In this manner, a ratio of height/width that satisfies the foregoing numerical value range can easily be obtained. The number of times of performing the application can be changed in accordance with the intended shape of the channel members.

The resin materials applied in layers may be either the same or different.

### Material

The supply-side channel members 4 may be formed from a material different from that of the separation membrane main body 30. The material different means a material that has a composition different from that of the material used for the separation membrane main body 30.

The components that constitute the supply-side channel members 4 are not particularly limited. However, in view of chemical resistance, polyolefin such as ethylene vinyl acetate copolymer resin, polyethylene or polypropylene, polyolefin copolymer and the like are preferable. Polymers such as polyurethane resin, epoxy resin or polystyrene, can also be selected. From the viewpoint of formability, these resins are suitable to provide void in channel members described later so that, with these resins, it is easy to provide the supply-side channel members 4 with void.

The planar shape of the supply-side channel members 4 may be a linear shape in the flowing direction f of supplied water, or can be changed to other shapes as long as the supply-side channel members 4 are protruded from the surface of the separation membrane main body 30 and the effects desired as the separation membrane element are not impaired. That is, the shape of the channel members in planar directions (xy plane) may be a curved line shape, a wavy line shape or the like. A plurality of channel members included in one separation membrane may also be formed to be different from each other in at least one of the width d and the length e.

### Provision of Void

A supply-side channel member can have a void portion. Although the method for disposing the supply-side channel member having a void portion on the separation membrane's supply-side surface is not particularly limited, there can be cited, for example, a chemical reactant gas-utilized method, a low-boiling point solvent-utilized method, a mechanical mix-in method, a solvent removal method, a die-pour foam molding method, a melt foam molding method, a solid-phase foam molding method, and a foam melt method. In the foam melt method, an inert gas mixed in a hot melt resin, which is applied to a separation membrane's supply-side surface. As a result, the hot melt resin solidifies in a state where the hot melt resin and the inert gas coexist so that the portions where the inert gas exists make void portions.

When the resin solidifies in a state where the resin has voids, a channel is not formed within the resin so that this method does not contribute to reduction in flow resistance. However, it is easy to increase the elevation difference of the applied resin, and the height h of the channel member can be increased even if the width d of the channel member is small. The method also has a characteristic of being capable of reducing the amount of usage of the resin applied.

Furthermore, since the resin that forms the supply-side channel members has voids, the supply-side channel members tend to be high in flexibility. Hence, even if the separation membrane expands and contracts when rolled around as mentioned above, or when operated for a long time, or when subjected to repetitions of the operation and the stop of pressure filtration, the supply-side channel members can follow the expansion and contract so that breakage is less likely to occur.

As for the separation membrane, the porosity of the supply-side channel members is preferred to be 5% or greater and 95% or less, and more preferably 40% or greater and 85% or less.

### Band-Shaped Region

When the supply-side channel members 4 described above are a first supply-side channel member, the separation membrane allows a second supply-side channel member to be disposed on a supply-side surface.

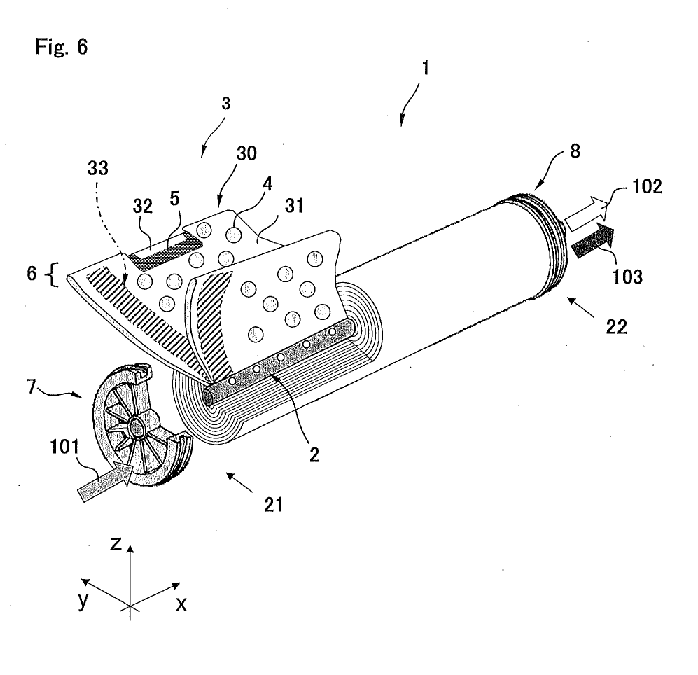

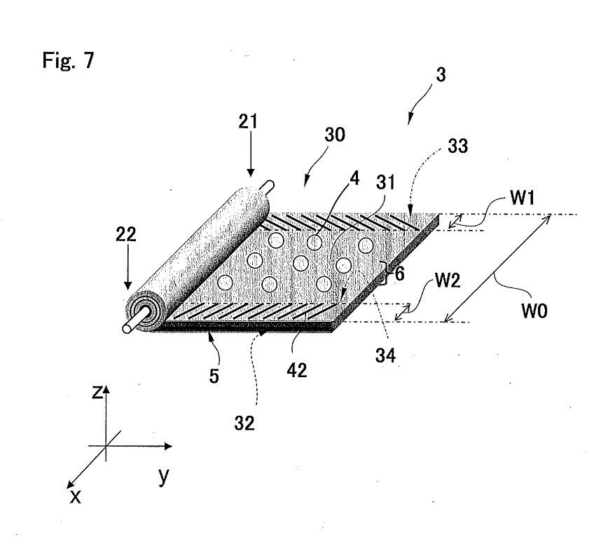

That is, on the supply-side surface 31 of the separation membrane main body 30, band-shaped regions 33 and 34 may be provided on end portions as second supply-side channel members 42. Because the second supply-side channel members 42 made up of the band-shaped regions 33 and 34 as shown in FIG. 6 and FIG. 7 exist on the end portions of the separation membrane 3, inflow of supplied water into the separation membrane element becomes easy, and the separation membrane can be stably operated even when pressure filtration is continued for a long time.

The edges of the band-shaped regions 33 and 34 do not need to coincide with edges of the separation membrane 3; instead, the band-shaped regions may be apart from the edges of the separation membrane. However, the distance between the band-shaped region 33 and an upstream side edge of the separation membrane and the distance between the band-shaped region 34 and a downstream side edge of the separation membrane are, for example, 5% or less, or 1% or less, of the width W0 of the separation membrane 3 in the x-axis direction. Thus, since the second supply-side channel members 42 are provided in the vicinity of the edges of the separation membrane with respect to the x-axis direction and, in particular, in the vicinity of the upstream side edge thereof, supplied water 101 is efficiently fed to the supply-side surface 31.

Furthermore, the “end portions” where the band-shaped regions are provided, concretely, refer to regions from the edges of the separation membrane 3 with respect to the x-axis direction up to 20% of the width W0 of the separation membrane 3 with respect to the x-axis direction. That is, the second supply-side channel members 42 are disposed within regions from the edges of the separation membrane 3 with respect to the x-axis direction to 20% of the width W0 of the separation membrane 3 with respect to the x-axis direction.

Furthermore, if a width W1 of the band-shaped region 33 and a width W2 of the band-shaped region 34 are 1% or greater of the width W0, raw fluid is stably fed to the supply-side surface 31.

Furthermore, the total of the widths W1-W2 of the band-shaped regions may be set to about 10% to 60% of the width W0. If the rate of the width W1-W2 to the width W0 is 60% or less, the flow resistance and the pressure loss are reduced. If this ratio is 10% or greater, the flow disturbing effect will restrain occurrence of concentration polarization. Furthermore, the widths W1 and W2 may each be 10% or greater of W0.

As an example of the foregoing configuration, in this example, the band-shaped regions 33 and 34 are identical in shape and size. That is, the widths W1 and W2 of the band-shaped regions in FIG. 7 are the same, and the shapes of the second supply-side channel members 42 are also the same. The widths W1 and W2 are each constant in the longitudinal direction (MD) of the separation membrane.

Thus, since the second supply-side channel members 42 are disposed on the end portions of the supply-side surface 31, channels of the supplied water 101 are secured between two facing supply-side surfaces 31. Although in this example, the two band-shaped regions 33 and 34 are provided in the one supply-side surface 31, our membranes, elements and methods are not limited to this form. Instead, the band-shaped region may be provided only on one of end portions with respect to the x-axis direction, that is, one of the upstream-side and downstream-side end portions.

As for the construction of the second supply-side channel members 42 such as the material, the shape and the like, substantially the same construction as that of the supply-side channel members 4 described above (for distinction, termed the first supply-side channel member) is applicable. However, in a separation membrane, the second supply-side channel members 42 and the first supply-side channel members 4 may be different from each other in the shape and the material applied. The second supply-side channel members 42 do not necessarily need to satisfy the ratio of height/width mentioned above with regard to the first supply-side channel members 4, but are more preferred to satisfy the ratio of height/width.

In the form shown in FIG. 7, one separation membrane 3 is provided with a plurality of second supply-side channel members 42. Each one of the supply-side channel members 42 is linear, and the extending direction thereof is set obliquely to the lengthwise direction (x-axis direction) of the water collecting pipe 2. Particularly in FIG. 7, the plurality of supply-side channel members 42 are disposed parallel to each other. That is, in FIG. 7, the second supply-side channel members 42 have a stripe shape.

The “oblique to the x-axis direction” means that being parallel (x-axis direction) and being orthogonal (y-axis direction) are excluded. That is, the angle θ between the x-axis direction and the extending direction of the supply-side channel members 42 exceeds 0° and is less than 90°. The angle θ is in absolute value. That is, two resin bodies axially symmetric to each other with respect to the x-axis exhibit the same angle θ.

Because the angle θ is less than 90°, the flow of the raw fluid 101 is disturbed so that the concentration polarization is unlikely to occur and therefore good separation performance is realized. Because the angle θ is greater than 0°, the effect of restraining the concentration polarization further increases. If the angle θ is 60° or less, the flow resistance of the raw fluid is relatively low, and high restraining effect with respect to concentration polarization can be obtained. Furthermore, to produce the flow disturbing effect while reducing the flow resistance, the angle θ is more preferred to be greater than 15° and less than or equal to 45°.

In the stripe-shaped arrangement of the second supply-side channel members, the upstream-side channel members and the downstream-side channel members may be parallel or not parallel to each other. For example, in the stripe-shaped arrangement, the upstream-side channel members and the downstream-side channel members may be either axially symmetric or asymmetric to each other with respect to the y-axis.

The foregoing first supply-side channel members 4 are disposed between the upstream-side band-shaped region 33 and the downstream-side band-shaped region 34 described above.

### 2. Separation Membrane Element

### (2-1) Overall Construction

Next, an example of the form of a spiral type separation membrane element will be described with reference to FIG. 6.

As shown in FIG. 6, a separation membrane element 1 includes a water collecting pipe 2, separation membranes 3, supply-side channel members 4, upstream-side band-shaped regions 33, filtrate-side channel members 5, a supply-side end plate 7, and a filtrate-side end plate 8. The separation membrane element 1 is capable of separating supplied water 101 into filtrate 102 and concentrated water 103.

The water collecting pipe 2 is a hollow cylindrical member elongated in one direction (an x-axis direction in the drawing). A side surface of the water collecting pipe 2 is provided with a plurality of holes.

It suffices that the separation membrane 3 is a membrane having a desired separation performance as stated above. The separation membrane 3 has a supply-side surface 31 that contacts the supplied water 101 and a filtrate-side surface 32 that contacts the filtrate 102.

The supply-side channel members 4 are provided on the supply-side surface 31 of the separation membrane 3.

As the filtrate-side channel member 5, a related-art channel member can be applied; for example, a knitted fabric such as tricot, is used. The filtrate-side channel member 5, in an envelope-shaped membrane 6, is disposed between two facing filtrate-side surfaces 32. However, the filtrate-side channel member 5 can be changed to another member that can form a filtrate-side channel between the separation membranes 3. If as the separation membrane 3, a separation membrane in which two facing filtrate-side surfaces 32 are provided with irregularities are used, the filtrate-side channel member 5 can be omitted. Details and other examples of the filtrate-side channel member will be described later.

The envelope-shaped membrane 6 is also referred to as “leaf” described above. The envelope-shaped membrane 6 is formed of two separation membranes 3 superposed on each other so that the filtrate-side surfaces 32 are inside, or of one separation membrane 3 that has been folded. A planar shape of the envelope-shaped membrane 6 is rectangular, and the separation membrane 3 is closed on three sides and open on one side. The envelope-shaped membrane 6 is disposed so that its opening portion faces the water collecting pipe 2, and, furthermore, is wrapped around the perimeter of the water collecting pipe 2. In the separation membrane element 1, a plurality of envelope-shaped membranes 6 are wound around to lie on top of each other. Outside surfaces of each envelope-shaped membrane 6 are supply-side surfaces 31, and adjacent envelope-shaped membranes 6 are disposed so that the supply-side surfaces 31 face each other. That is, supply-side channels are formed between adjacent envelope-shaped membranes 6, and filtrate-side channels are formed inside the envelope-shaped membranes 6.

A roll body made up of the water collecting pipe and the plurality of envelope-shaped membranes rolled around the perimeter of the water collecting pipe includes, on its two end portions, the supply-side end plate 7 that allows the supplied water 101 to pass through, and the filtrate-side end plate 8 that allows the filtrate 102 and the concentrated water 103 to pass through. The supply-side end plate 7 and the filtrate-side end plate 8 are attached to an upstream-side end portion 21 and a downstream-side end portion 22, respectively, of the roll body.

The separation membrane element 1 can include members other than what are mentioned above. For example, the perimeter of the roll body of the separation membrane may be covered with another member such as a film.

The supplied water 101 is fed to the supply-side surfaces 31 of the separation membranes 3 via the supply-side end plate 7. The filtrate 102 having permeated through the separation membrane 3 passes through the channels formed within the envelope-shaped membranes 6 by the filtrate-side channel members 5, and then flows into the water collecting pipe 2. The filtrate 102 having flown through the water collecting pipe 2 is discharged to the outside of the separation membrane element 1, via the end plate 8. The concentrated water 103 passes through the supply-side surfaces 31, and is discharged from the end plate 8 to the outside. In this manner, the supplied water 101 is separated into the filtrate 102 and the concentrated water 103.

### (2-2) Separation Membrane

As for the separation membranes 3, the construction described above is applied as shown in FIG. 6 and FIG. 7. The separation membranes 3 are wound around the perimeter of the water collecting pipe 2, and are disposed so that the width direction (CD) of the separation membranes 3 is along the lengthwise direction of the water collecting pipe 2. As a result, the separation membranes 3 are disposed so that the longitudinal direction (MD) thereof is along the winding direction.

“Inside with respect to the winding direction” and “outside with respect to the winding direction” can be paraphrased into a near side and a far side, respectively, of each separation membrane relative to the water collecting pipe.

As described above, since the channel members do not need to reach the edges of the separation membranes, it is permissible that, for example, the outside end portions of each envelope-shaped membrane with respect to the winding direction and an end portion of each envelope-shaped membrane with respect to the water collecting pipe lengthwise direction are not provided with a channel member.

### (2-3) Supply-Side Channel

As shown in FIG. 6, channels are formed between the separation members 3, by the supply-side channel members mentioned above, as envelope-shaped membranes 6 each made up of separation membranes 3 are superposed on each other and wound around. It is not necessary that both the facing supply-side surfaces be provided with first supply-side channel members 4, and it suffices that at least one the facing supply-side surfaces is provided with first supply-side channel members 4.

If the second supply-side channel members 42 are disposed on both the facing supply-side surfaces to intersect each other, larger height of the channel can be secured.

### (2-4) Filtrate-Side Channel

It suffices that the filtrate-side channel member 5 is constructed so that filtrate can reach holes provided in the water collecting pipe. The shape, size, material and the like of the filtrate-side channel member 5 are not limited by concretely constructions.

The filtrate-side channel members 5, having a composition different from that of the separation membrane, are capable of exhibiting high resistance to pressure than the separation membranes. Concretely, the filtrate-side channel members 5 are preferred to be formed from a material that has a higher shape retaining capability, particularly, with respect to pressure in a direction perpendicular to the planar directions of the separation membranes than the separation membranes. Due to this, the filtrate-side channel members 5 can secure filtrate-side channels even after repeated passage of water or passage of water under high pressure.

For example, as the filtrate-side channel members 5, a tricot, a coarse net-shaped material, a rod-shaped, cylinder-shaped or dot-shaped material, a foamed material, a powder-shaped material, combinations thereof and the like can be used. Furthermore, a filtrate-side channel member 5 can be fixed to the filtrate-side surface 32 of the separation membrane main body 30. The composition is not particularly limited. However, in view of chemical resistance, resins such as polyolefins including ethylene vinyl acetate copolymer resin, polyethylene and polypolypropylene, polyolefin copolymer, or polyester, urethane, epoxy and the like, are preferable, and it is possible to use not only thermoplastic resins but also heat or light setting resins. These can be used singly or as a mixture of two or more kinds. However, if the resin is a thermoplastic resin, the forming is easy, and the shape of the channel member can be uniform.

As for the material that forms the filtrate-side channel members 5, a composite material that contains these resins as a matrix and further contains a filling material is also applicable. The compression elasticity modulus of the channel member can be enhanced by adding to the matrix a filling material such as a porous inorganic substance. Concretely, silicates of alkaline earth metals, including sodium silicate, calcium silicate, magnesium silicate and the like, metal oxides, including silica, alumina, titanium oxide and the like, carbonates of alkaline earth metals, including calcium carbonate, magnesium carbonate and the like, can be used as a filling material. The amount of the filling material added is not particularly limited as long as the advantageous effects are not impaired.

When the filtrate-side channel member 5 is fixed to the filtrate-side surface 32, the separation membrane main body 30 and, more concretely, the base material 38 may be impregnated with components of the filtrate-side channel member 5. If the channel member 5 is disposed on the base material 38 side of the separation membrane main body, that is, on the filtrate-side surface 32, and is heated from the base material side in a hot melt method or the like, the impregnation with the filtrate-side channel member 5 progresses from the reverse side toward the obverse side of the separation membrane. As the impregnation progresses, the adhesion between the channel member and the base material becomes firm, and the channel member is less likely to peel from the base material even in pressure filtration.

However, if impregnation with a component of the filtrate-side channel member 5 reaches the vicinity of the separation function layer (supply-side surface 31), the impregnated channel member will break the separation function layer when pressure filtration is performed. Therefore, when a component of the filtrate-side channel member 5 has impregnated the base material, the proportion of the impregnation thickness of the filtrate-side channel member 5 to the thickness of the base material (that is, impregnation rate) is preferred to be 5% or greater and 95% or less, and more preferred to be 10% or greater and 80% or less, and even more preferred to be 20% or greater and 60% or less. The impregnation thickness refers to a channel member maximum impregnation thickness, and the channel member maximum impregnation thickness means, in a cross-section, a maximum value of the thickness of the impregnated portion corresponding to the channel member.

The impregnation thickness of the filtrate-side channel member 5 is adjustable by, for example, changing the kinds of materials (more concretely, the kinds of resins) and/or the amounts of materials that constitute the filtrate-side channel member 5. When the filtrate-side channel member 5 is provided by the hot melt method, the impregnation thickness can also be adjusted by changing the process temperature or the like.

If, by subjecting the base material that includes the impregnated portion of the filtrate-side channel member 5 to a thermal analysis such as a differential scanning calorimetry, a peak resulting from a component of the filtrate-side channel member 5, other than from the base material, is obtained, it can be confirmed that the channel member 5 has impregnated the base material.

As for the rate of impregnation of the filtrate-side channel member 5 into the base material, the channel member impregnation thickness and the base material thickness can be calculated on the basis of observation of a cross-section of the separation membrane where the filtrate-side channel member 5 exists, under a scanning electron microscope, a transmission electron microscope or an atomic force microscope. For example, if the observation is made under a scanning electron microscope, the separation membrane, together with the filtrate-side channel member 5, is cut in the depth direction, and the cross-section is observed under the scanning electron microscope, and the channel member impregnation thickness and the base material thickness are measured. Then, the impregnation rate can be calculated from the ratio between the channel member maximum impregnation thickness where the impregnation of the filtrate-side channel member 5 into the base material is greatest and the base material thickness. “Base material thickness” in the case of calculating the impregnation depth is the thickness of the base material at the site that is the same as the portion where the maximum impregnation thickness is measured.

The filtrate-side channel member 5 may be of a continuous shape or a discontinuous shape.

As for the filtrate-side channel member 5, tricot has already cited as an example of the member that has a continuous shape. The definition of continuity has already been stated. As the member that has a continuous shape, there can be further cited woven fabrics, knitted fabrics (nets or the like), nonwoven fabrics, porous materials (porous films or the like), and so forth.

The definition of discontinuity has also already been stated. As the shape of a discontinuous channel member, concretely, there can be cited dot shapes, particle shapes, linear shapes, hemisphere shapes, cylindrical shapes (including circular cylindrical shapes, polygonal cylindrical shapes and the like) or wall shapes and the like. It suffices that a plurality of channel members of a linear shape or a wall shape provided on one separation membrane are disposed not to intersect each other. Concretely, they may be disposed parallel to each other.

The shape of the individual resin bodies that constitute the filtrate-side channel members of a discontinuous shape is not particularly limited. However, it is preferred that the flow resistance of the filtrate channels be small, and the channels be stable when the raw fluid is fed into and permeated through the separation membrane element. As a planar view image obtained when one unit of a discontinuously shaped filtrate-side channel member is observed from a direction perpendicular to the filtrate-side surface of the separation membrane, for example, an ellipse, a circle, an oval, a trapezoid, a triangle, a rectangle, a square, a parallelogram, a rhombus or an indefinite shape can be cited. In a cross-section perpendicular to planar directions of the separation membrane, the filtrate-side channel member may be of any of a shape whose width expands, a shape whose width narrows and a shape that has a consistent width from an upper portion toward a lower portion (that is, from a vertex of the filtrate-side channel member in the thickness direction toward the separation membrane provided with the filtrate-side channel member).

The thickness of the filtrate-side channel member in the separation membrane element is preferred to be 30 μm or greater and 1000 μm or less, and more preferably 50 μm or greater and 700 μm or less, and even more preferably 50 μm or greater and 500 μm or less. Within such a range, the thickness makes it possible to secure a stable channel for filtrate.

The thickness of the filtrate-side channel member can be freely adjusted to satisfy required conditions regarding the separation characteristic and the permeation performance, for example, when the discontinuously shaped filtrate-side channel member is disposed by the hot melt processing method, by changing the process temperature or the resin for a hot melt purpose.

### (2-5) Water Collecting Pipe

It suffices that the water collecting pipe 2 is constructed so that filtrate flows therein, and the material, the shape, the size and the like thereof are not particularly limited. As the water collecting pipe 2, for example, a hollow cylindrical member having a side surface provided with a plurality of holes is used.

### 3. Production Method for Separation Membrane Element

### (3-1) Production of Separating Membrane Main Body

Although the production method for the separation membrane main body has been described above, the production method can be briefly summarized as follows.

A resin is dissolved in a good solvent. The obtained resin solution is cast onto a base material, which is followed by immersion in pure water so that a porous support layer and the base material are composited. After that, as mentioned above, a separation function layer is formed on the porous support layer. Furthermore, to enhance the separation performance and the permeation performance according to need, chemical processes with chloride, acid, alkali, nitrous acid and the like are performed, and monomers and the like are washed to fabricate a continuous sheet of a separation membrane main body.

### (3-2) Arrangement of Supply-Side Channel Member

The supply-side channel members 4 are formed on the supply-side surface of the separation membrane main body 30 by fixing discontinuous channel members thereto. This step may be performed at any time in the production of the separation membrane. For example, the channel member may be provided before the porous support layer is formed on the base material, or may also be provided after the porous support layer is provided but before the separation function layer is formed, or may also be performed at a time point that is after the separation function layer is formed and that is before or after above-described chemical process is performed.

The method of disposing the channel members is as described above.

### (3-3) Formation of Filtrate-Side Channel

When the filtrate-side channel member 5 is a discontinuous member that is fixed to the filtrate-side surface and that is formed from a material different from that of the separation membrane main body 30, the same method and timing as applied to formation of the supply-side channel member can be applied to formation of the filtrate-side channel member.

On another hand, when the filtrate-side channel member 5 is a member that is continuously formed such as a tricot, it suffices that after a separation membrane in which the supply-side channel member is disposed on the separation membrane main body 30 is produced, the separation membrane and the filtrate-side channel member 5 are superposed on each other.

### (3-4) Laminating and Winding of Separation Membranes

For production of a separation membrane element, a related-art element fabrication apparatus can be used. As the element fabrication method, methods mentioned in reference documents (Japanese Examined Patent Publication (Kokoku) No. 44-14216, Japanese Examined Patent Publication (Kokoku) No. 4-11928, and Japanese Unexamined Patent Publication (Kokai) No. 11-226366) can be used. Details of the method are as follows.

By folding one separation membrane so that the filtrate-side surface faces inward and sticking the peripheral edges thereof together, or by superposing two separation membranes so that the filtrate-side surfaces face inward and sticking the peripheral edges thereof, an envelope-shaped membrane is formed. As described above, three sides of the envelope-shaped membrane are sealed. The sealing can be carried out by an adhesive, or adhesion by hot melt, fusion by heat or laser or the like.

As for the adhesive for use for formation of the envelope-shaped membrane, the viscosity is preferred to be 40 PS or greater and 150 PS or less, and more preferred to be 50 PS or greater and 120 PS or less. If a crease occurs in a separation membrane, the performance of the separation membrane element sometimes declines. However, if the viscosity of the adhesive is 150 PS or less, a crease is less likely to occur when the separation membranes are rolled around the water collecting pipe. When the viscosity of the adhesive is 40 PS or greater, the outflow of the adhesive from between the separation membranes can be depressed, and the risk of the adhesive depositing on a non-required portion declines.

The amount of the adhesive applied is preferred to be an amount such that after the separation membranes are rolled around the water collecting pipe, the widths of the portions where the adhesive has been applied is 10 mm or greater and 100 mm or less. Due to this, the separation membrane are certainly adhered so that the inflow of a raw fluid to the filtrate-side is depressed. As for the effective membrane area, a relatively large area can be secured.

As the adhesive, urethane-based adhesives are preferred. To have the viscosity within the range of 40 PS or greater and 150 PS or less, the adhesive is preferred to be an adhesive in which isocyanate as a main agent and polyol as a hardening agent are mixed at a weight proportion of isocyanate:polyol=1:1 to 1:5. As for the viscosity of the adhesive, the viscosities of the main agent and the hardening agent alone and of a mixture of a prescribed compounding proportion are measured by a B type viscometer (JIS K 6833) beforehand.

The separation membrane (envelope-shaped membrane) to which the adhesive has been applied and which has been formed in an envelope shape is disposed so that the closed portion of the envelope-shaped membrane is located inside with respect to the winding direction, and communication with holes provided on the water collecting pipe is obtained, and the separation membrane is wrapped around the perimeter of the water collecting pipe. In this manner separation membranes are wound in a spiral manner.

### (3-5) Other Steps

The production method for the separation membrane element may include further wrapping a film, a filament or the like on the outside of the roll body of separation membranes formed as described above, and may include further steps such as edge cutting in which ends of the separation membranes in the lengthwise direction of the water collecting pipe are cut straight, the mounting of end plates or the like.

### 4. Utilization of Separation Membrane Element

The separation membrane elements may also be connected in series or parallel and housed in a pressure vessel to be used as a separation membrane module.

The separation membrane element and the separation membrane module mentioned above can be combined with a pump that feeds a fluid to them, an apparatus that pre-treats the fluid and the like to construct a fluid separation apparatus. By using this fluid separation apparatus, it is possible to, for example, separate a supplied water into a filtrate such as drinking water, and a concentrated water that has not passed through the membrane and therefore obtain a water that meets the purpose.

Higher operating pressures of the fluid separation apparatus will improve the removal rate. However, considering increases of the energy needed for operation and also the retentivity of the feed channels and the permeate channels of the separation membrane element, the operating pressure for permeation of water to be treated (supplied water) through the membrane module is preferred to be 0.2 to 5 MPa. While increases in the supplied water temperature decrease the salt removal rate, decreases in the supplied water temperature gradually reduce the membrane permeate flux. Therefore, the supplied water temperature is preferred to be 5 to 45° C. When the pH of the supplied water is in a neutral region, scale of magnesium and the like is depressed from occurring and degradation of the membrane is also depressed even when the supplied water is a liquid with a high salt concentration such as seawater.

The fluid that is processed by the separation membrane element is not particularly limited. However, when the separation membrane element is used for water processing, liquid-state mixtures containing 500 mg/L to 100 g/L of TDS (Total Dissolved Solids) such as seawater, saline water and drainage water, can be cited as supplied water. Generally, TDS refers to the amount of total dissolved solids, and is represented by “mass volume” or “weight ratio.” According to the definition, TDS can be calculated from the weight of the residue obtained by evaporating, at a temperature of 39.5 to 40.5° C., a solution filtered through a filter of 0.45 μm. However, in a simple way, TDS is converted from the practical salinity (S).

### EXAMPLES

Our membranes, elements and methods will be described further in detail below with reference to examples. However, this disclosure is not limited at all by these examples.

### Height of Supply-Side Channel Members of Separation Membrane

Using a high accuracy shape measurement system KS-1100 manufactured by Keyence Corporation, average heights h of supply-side channel members were analyzed from results of measurement on the supply-side surfaces of 5 cm×5 cm. 30 sites with elevation differences of 10 μm or greater were subjected to measurement, and a value obtained by summing the values of the height of the sites was divided by the total number of sites of measurement to find an average height. When the filtrate-side channel member was to be fixed to the filtrate-side surface of a separation membrane, the height of the filtrate-side channel members was found in substantially the same manner as mentioned above.

### Width, Pitch and Interval of Supply-Side Channel Members

Using a scanning electron microscope (S-800) (manufactured by Hitachi, Ltd.), 30 arbitrary supply-side channel member's cross-sections were photographed at a magnification of 500 times. As for the width of supply-side channel members, maximum widths in a direction perpendicular to the designed flowing direction of supplied water were measured at 200 sites, and an average thereof was determined as a width d.

On another hand, as for the pitch of the supply-side channel members, a horizontal distance from the highest point on a high site to the highest site on an adjacent high site on the supply side of the separation membrane was measured at 200 sites, and an average value thereof was determined as the pitch. The interval between immediately adjacent supply-side channel members was found by measuring the shortest distances at 200 sites, and calculating an average value thereof.

At the time of fixing filtrate-side channel members to the filtrate-side surface of a separation membrane, the width, pitch and interval of the filtrate-side channel members were found in substantially the same manner as mentioned above.

### Projected Area Ratio of Supply-Side Channel Members

A separation membrane together with supply-side channel members was cut into 5 cm×5 cm. Using a laser microscope (the magnification was selected from 10 to 500 times), the total projected area of the channel members was measured by moving the stage. A value obtained by dividing the projected area obtained when the channel members were projected from the separation membrane supply side by the cut-out area was determined as the projected area ratio. At the time of fixing filtrate-side channel members to the filtrate-side surface of a separation membrane, the projected area ratio of the filtrate-side channel members was found in substantially the same manner as mentioned above.

### Amount of Water Production

Using a separation membrane or a separation membrane element and using as a supplied water a salt solution of 500 mg/L in concentration and pH 6.5, operation was performed for 100 hours at an operation pressure of 0.7 MPa and an operation temperature of 25° C., and then sampling for 10 minutes was carried out. The amount of water permeation (cubic meter) per unit area of the membrane and per day was represented as the amount of water production (m³/day).

### Demineralization Rate (TDS Removal Rate)

The TDS concentrations of the supplied water and the filtrate sampled in the measurement of the amount of water production were found by conductivity measurement, and a TDS removal rate was calculated from the following expression:

TDS removal rate(%)=100×{1−(TDS concentration in filtrate/TDS concentration in supplied water)}.

When a value measured after one hour and the value measured after two hours showed a change of 0.1% or greater, the result was noted.

### Porosity of Supply-Side Channel Members

Using a high accuracy shape measurement system KS-1100 manufactured by Keyence Corporation, a cross-section of a supply-side channel member obtained by cutting a center thereof was observed. The ratio of the total area of void portions to the cross-sectional area of the supply-side channel member was determined as the porosity.

### Stability A

A separation membrane element fabricated was operated for 1 minute by using as a raw water to the element a salt solution of 500 mg/L in concentration and pH 6.5 and 25° C. at an operation pressure of 0.7 MPa, and then the operation was ended. The stop time following the 1-minute water production operation was set to 1 minute, which was determined as 1 cycle. After this cycle (start-stop) was repeated 1500 times, the demineralization rate was measured, and the stability A of the demineralization rate was found from the following expression:

Stability A(%)=(demineralization rate after 1500 times of start-stop)/initial amount of water production×100.

### Stability B

After the evaluation of stability A was ended, the element was operated for 1 minute by using as a raw water a salt solution of 500 mg/L in concentration and pH 6.5 and 25° C. at an operation pressure 1.0 MPa, and then the operation was ended. The stop time following the 1-minute water production operation was set to 1 minute, which was determined as 1 cycle. After this cycle (start-stop) was repeated 1000 times, the demineralization rate was measured, and the stability B of the demineralization rate was found from the following expression. For the initial amount of water production mentioned herein, results obtained at the time of evaluation of the stability A were used. When the stability A was below 70, this test was not conducted.

Stability B(%)=(demineralization rate after 1000 times of start-stop)/initial amount of water production×100

### Progress Degree of Fouling

A nonionic surface active agent (manufactured by Wako Pure Chemical Industries, Ltd., polyoxyethylene(10)octylphenyl ether) was injected into the supplied water so that 100 ppm was obtained. With respect to the amount of separation membrane element filtrate obtained from the supplied water (a nonionic surface active agent-containing saline water, 25° C.) after 1 hour of water passage, the amount of water permeation (cubic meter) per separation membrane element and per day was determined as the amount of water production (m³/day) subsequent to injection of the nonionic surface active agent.

The progress degree of fouling is the rate of change in the amount of water production between before and after injection of the nonionic surface active agent, and is expressed as in “(the amount of water production before injection of the nonionic surface active agent—the amount of water production after injection of the nonionic surface active agent)/(the amount of water production after injection of the nonionic surface active agent)×100(%).” The closer to 0% the progress degree of fouling exhibited by a membrane is, the less likely fouling is to occur on the membrane.

### Example 1

By casting a DMF solution of 15.0 wt % of polysulfone to a thickness of 180 μm at room temperature (25° C.) on a nonwoven fabric made of polyethylene terephthalate fiber (Yarn diameter: 1 decitex. Thickness: about 90 μm. Air permeability: 1 cc/cm²/sec.), and immediately immersing it in pure water and leaving it standing for 5 minutes, a roll of a porous support layer (130 μm in thickness) made of a fiber-reinforced polysulfone support membrane was fabricated.

After that, the porous support layer roll was rolled out, and a 1.8 wt % m-phenylene diamine (m-PDA) and 4.5 wt % ε-caprolactam aqueous solution was applied to the polysulfone surface, and then nitrogen was blown thereto from an air nozzle to remove a surplus amount of the aqueous solution from the support membrane surface. Then an n-decane solution of 25° C. containing 0.06 wt % of trimesic acid chloride was applied to the surface so that the surface was completely wet. After that, a surplus amount of the solution was removed from the membrane by air blowing, and the washing with hot water at 80° C. was performed, and liquid was eliminated by air blowing to obtain a separation membrane roll.

Subsequently, using a foam melt system on the supply-side surface of the separation membrane, an ethylene vinyl acetate copolymer resin (trade name: 701A) at a resin temperature of 110° C., with a nitrogen gas being mixed in, was applied in the shape of dots at a running speed of 2.5 m/min to dispose supply-side channel members (height h=0.83 mm, width d=0.5 mm, a porosity of 80%, an aspect ratio of 1, a pitch of 1.8 mm in the length direction of the separation membrane (y-axis direction), and an angle of 90° formed between two supply-side channel members 4 adjacent in the flowing direction of the supplied water (mentioned as formed angle in tables)).

A portion of 43 cm² of the separation membrane in which dot-shaped supply-side channel members were disposed was cut out, and placed in a pressure vessel, and operation was performed under the foregoing conditions. The amount of water production and the demineralization rate were 1.02 m³/m²/day and 98.7%.

Hereinafter, results of Examples and Comparative Examples are shown in Table 1 to Table 6.

### Example 2

The separation membrane roll obtained in Example 1 was subjected to a folding and cutting process so that the effective area in a separation membrane element became 37.0 m². Thus, with a tricot (Thickness: 0.3 mm. Groove width: 0.2 mm. Ridge width: 0.3 mm. Groove depth: 0.105 mm) as the filtrate-side channel members, 26 leaves were fabricated with a width of 1,000 mm.

After that, a separation membrane element in which 26 leaves were wrapped around in a spiral form while being wrapped around a water collecting pipe made of ABS (Width: 1,020 mm. Diameter: 30 mm. The number of pores was 40× linear 1 row.) was fabricated. A film was wrapped around the outer periphery thereof, and was fixed by a tape. After that, edge cutting was performed, and end plates were attached, and filament winding was performed, to fabricate an 8-inch element.

The element was placed in a pressure vessel, and operation was performed under the foregoing conditions. The amount of water production and the demineralization rate were 31.2 m³/day and 98.8%, the stability A was 99.5% or greater, the stability B was 99% or greater, and the progress degree of fouling was 39.0%.

### Example 3

A separation membrane roll was fabricated in substantially the same manner in all respects as in Example 1, except that the feed amount ratio between the resin and the nitrogen gas was changed and the porosity of supply-side channel members was changed to 50%.

Using the separation membrane roll, an 8-inch element was fabricated in substantially the same manner as in Example 2.

The element was placed in a pressure vessel, and operation was performed under the foregoing conditions. The amount of water production and the demineralization rate were 31.0 m³/day and 98.8%, the stability A was 99.5% or greater, the stability B was 98.2%, and the progress degree of fouling was 39.0%.

### Example 4

A separation membrane roll was fabricated in substantially the same manner in all respects as in Example 1, except that the feed amount ratio between the resin and the nitrogen gas was changed and the porosity of supply-side channel members was changed to 5%.

Using the separation membrane roll, an 8-inch element was fabricated in substantially the same manner as in Example 2.

The element was placed in a pressure vessel, and operation was performed under the foregoing conditions. The amount of water production and the demineralization rate were 31.0 m³/day and 98.8%, the stability A was 99.5% or greater, the stability B was 96.2%, and the progress degree of fouling was 38.9%.

### Example 5

A separation membrane roll was fabricated in substantially the same manner in all respects as in Example 1, except that the feed amount ratio between the resin and the nitrogen gas was changed and the porosity of supply-side channel members was changed to 88%.

Using the separation membrane roll, an 8-inch element was fabricated in substantially the same manner as in Example 2.

The element was placed in a pressure vessel, and operation was performed under the foregoing conditions. The amount of water production and the demineralization rate were 31.1 m³/day and 98.8%, the stability A was 99.5% or greater, the stability B was 99.6%, and the progress degree of fouling was 39.1%.

### Example 6

A separation membrane roll was fabricated in substantially the same manner in all respects as in Example 1, except that the width d of supply-side channel members was changed to 0.3 mm and the pitch thereof in the length direction of the separation membrane was changed to 1.0 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 31.6 m³/day and 99.0%, the stability A was 99.5% or greater, the stability B was 99.6%, and the progress degree of fouling was 36.0%.

### Example 7

A separation membrane roll was fabricated in substantially the same manner in all respects as in Example 1, except that the width d of supply-side channel members was changed to 1.2 mm and the pitch thereof in the length direction of the separation membrane was changed to 2.7 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.1 m³/day and 98.5%, the stability A was 99.5% or greater, the stability B was 99.2%, and the progress degree of fouling was 42.2%.

### Example 8

A separation membrane roll was fabricated in substantially the same manner in all respects as in Example 1, except that the angle formed by two supply-side channel members 4 adjacent in the flowing direction of the supplied water was changed to 30° and the pitch in the length direction of the separation membrane was changed to 5.6 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.5 m³/day and 98.5%, the stability A was 99.5% or greater, the stability B was 99.5%, and the progress degree of fouling was 42.5%.

### Example 9

A separation membrane roll was fabricated in substantially the same manner in all respects as in Example 1, except that the angle formed by two supply-side channel members 4 adjacent in the flowing direction of the supplied water was changed to 45° and the pitch in the length direction of the separation membrane was changed to 1.6 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.0 m³/day and 98.6%, the stability A was 99.5% or greater, the stability B was 99.5%, and the progress degree of fouling was 41.0%.

### Example 10

A separation membrane roll was fabricated in substantially the same manner in all respects as in Example 1, except that the angle formed by two supply-side channel members 4 adjacent in the flowing direction of the supplied water was changed to 150° and the pitch in the length direction of the separation membrane was changed to 1.4 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.3 m³/day and 98.5%, the stability A was 99.5% or greater, the stability B was 99.5%, and the progress degree of fouling was 42.4%.

### Example 11

A separation membrane roll was fabricated in substantially the same manner in all respects as in Example 1, except that on both side end portions on the supply side of the separation membrane main body, band-shaped regions of 40 mm in width made up of stripe-shaped second supply-side channel members 42 (a linear rectangular parallelepiped shape inclined at 45° relative to the x-axis direction, 0.415 mm in height, and 1 mm in width) were provided. The dot-shaped supply-side channel members 4 were provided on only one of the supply-side surfaces that faced each other when incorporated in the element, and the band-shaped regions made up of second supply-side channel members 42 were provided on both of the supply-side surfaces that faced each other.

After that, an 8-inch element was fabricated in substantially the same manner as in Example 2.

The element was placed in a pressure vessel, and operation was performed under the foregoing conditions. The amount of water production and the demineralization rate were 30.5 m³/day and 99.0%, the stability A was 99.5% or greater, the stability B was 99.5%, and the progress degree of fouling was 41.5%.

### Example 12

A separation membrane roll was fabricated in substantially the same manner as in Example 1, except that as filtrate-side channel members, filtrate-side channel members were fixed instead of the tricot. As for the filtrate-side channel members, using on the filtrate-side surface of the separation membrane an applicator loaded with a comb shim whose slit width was 0.5 mm and whose pitch in the length direction of the separation membrane was 1.0 mm, an ethylene vinyl acetate copolymer resin (trade name: 701A) was applied at a resin temperature of 130° C. and a running speed of 5.5 m/min, linearly so that when a separation membrane element was made, the direction of the applied resin was perpendicular to the lengthwise direction of the water collecting pipe, and so that when an envelope-shaped membrane was made, the direction of the applied resin, from the end portion inside with respect to the winding direction to the end portion outside with respect to the winding direction, was perpendicular to the lengthwise direction of the water collecting pipe, and while the temperature of the backup roll was adjusted to 20° C. Thus, the filtrate-side channel members, with the height of the filtrate-side channel members being 0.3 mm, and the width of the channel members being 0.9 mm, the interval of the channel members in the lengthwise direction of the water collecting pipe being 0.5 mm, the pitch thereof being 1.0 mm, and the projected area ratio being 0.50, were fixed to the entire separation membrane.

Using the separation membrane roll obtained in this manner, an 8-inch element was fabricated in substantially the same manner as in Example 2.

The element was placed in a pressure vessel, and operation was performed under the foregoing conditions. The amount of water production and the demineralization rate were 35.7 m³/day and 98.5%, the stability A was 99.5% or greater, the stability B was 99.5%, and the progress degree of fouling was 40.0%.

### Example 13

A separation membrane roll was fabricated in substantially the same manner in all respects as in Example 12, except that band-shaped regions of 40 mm in width were provided on both side end portions on the supply side of the separation membrane main body. The dots were provided on only one of the supply-side surfaces that faced each other when incorporated in an element, and the band-shaped regions were provided on both of the supply-side surfaces that faced each other.

After that, an 8-inch element was fabricated in substantially the same manner as in Example 2.

The element was placed in a pressure vessel, and operation was performed under the foregoing conditions. The amount of water production and the demineralization rate were 35.0 m³/day and 98.7%, the stability A was 99.5% or greater, the stability B was 99.5%, and the progress degree of fouling was 42.2%.

### Example 14

A separation membrane roll was fabricated in substantially the same manner in all respects as in Example 1, except that, using a urethane foam solution application processing machine, supply-side channel members substantially the same as in Example 1 were formed on a biaxial drawing polyester film (Lumirror S Type 50 μm made by Toray), and then the supply-side channel members were transferred to the separation membrane supply side at 80° C.

Using the separation membrane roll, an 8-inch element was fabricated in substantially the same manner as in Example 2. The element was placed in a pressure vessel, and operation was performed under the foregoing conditions. The amount of water production and the demineralization rate were 31.2 m³/day and 98.8%, the stability A was 99.5% or greater, the stability B was 99.7%, and the progress degree of fouling was 39.0%.

### Example 15

The arrangement to supply-side channel members to the separation membrane was changed. Using a gravure roll, applying an ethylene vinyl acetate copolymer resin (trade name: 701A) in a dot shape at a resin temperature of 110° C. and a running speed of 3.0 m/min while adjusting the temperature of the backup roll to 20° C. was repeated to dispose supply-side channel members (height h=0.83 mm, width d=0.52 mm, a porosity of %, an aspect ratio of 1, a pitch of 1.8 mm in the length direction of the separation membrane, and an angle of 90° formed by two supply-side channel members 4 adjacent in the flowing direction of the supplied water (mentioned as formed angle in tables)). The resin corresponding to the first supply-side channel members 4 was disposed on only one of the supply-side surfaces that faces when incorporated in an element.

A portion of 43 cm² of the separation membrane in which dots were disposed was cut out, and placed in a pressure vessel, and operation was performed under the foregoing conditions. The amount of water production and the demineralization rate were 1.02 m³/m²/day and 98.6%.

### Example 16

With the separation membrane roll obtained in Example 15, an 8-inch element was fabricated by substantially the same method as in Example 2.

The element was placed in a pressure vessel, and operation was performed under the foregoing conditions. The amount of water production and the demineralization rate were 31.3 m³/day and 98.7%, the stability A was 99% or greater, the stability B was 95.8%, and the progress degree of fouling was 38.8%.

### Example 17

A separation membrane roll was fabricated in substantially the same manner in all respects as in Example 15, except that the resin used for separation membrane channel members was a modified polyolefin (trade name: PHC-9275) and applying it in a dot shape and a zigzag shape at a resin temperature of 160° C. and a running speed 7.5 m/min was repeated so that channel members, with the height h=0.83 mm, the width d=0.3 mm, and the pitch in the length direction of the separation membrane being 1.0 mm, were fixed to the supply-side surface of the separation membrane.

A portion of 43 cm² of the separation membrane in which dots were disposed was cut out, and placed in a pressure vessel, and operation was performed under the foregoing conditions. The amount of water production and the demineralization rate were 1.03 m³/m²/day and 98.6%.

### Example 18

Using the separation membrane roll obtained in Example 17, an 8-inch element was fabricated in substantially the same manner as in Example 2.

The element was placed in a pressure vessel, and operation was performed under the foregoing conditions. The amount of water production and the demineralization rate were 32.0 m³/day and 98.3%, the stability A was 99% or greater, the stability B was 95.0%, and the progress degree of fouling was 35.9%.

### Example 19

A separation membrane roll was fabricated in substantially the same manner in all respects as in Example 15, except that the resin used for channel members was a modified polyolefin (trade name: RH-105) and applying it in a dot shape and a zigzag shape at a resin temperature of 130° C. and a running speed 2 m/min was repeated so that channel members, with the height h=0.83 mm, the width d=0.7 mm, the pitch in the length direction of the separation membrane being 2.3 mm, and the projected area ratio being 0.08, were fixed to the separation membrane's supply-side surface.

A portion of 43 cm² of the separation membrane in which dots were disposed was cut out, and placed in a pressure vessel, and operation was performed under the foregoing conditions. The amount of water production and the demineralization rate were 1.03 m³/m²/day and 98.2%.

### Example 20

Using the separation membrane roll obtained in Example 19, an 8-inch element was fabricated in substantially the same manner as in Example 2.

The element was placed in a pressure vessel, and operation was performed under the foregoing conditions. The amount of water production and the demineralization rate were 30.5 m³/day and 98.8%, the stability A was 99% or greater, the stability B was 95.6%, and the progress degree of fouling was 41.0%.

### Example 21

A separation membrane roll was fabricated in substantially the same manner in all respects as in Example 15, except that the resins used for channel members was a modified polyolefin (trade name: RH-105), and applying it in a dot shape and a zigzag shape at a resin temperature of 125° C. and a running speed 2 m/min was repeated so that channel members, with the height h=0.83 mm, the width d=0.83 mm, the pitch in the length direction of the separation membrane being 2.8 mm, and the projected area ratio being 0.08, were fixed to the separation membrane's supply-side surface.

A portion of 43 cm² of the separation membrane in which dots were disposed was cut out, and placed in a pressure vessel, and operation was performed under the foregoing conditions. The amount of water production and the demineralization rate were 1.02 m³/m²/day and 98.6%.

### Example 22

Using the separation membrane roll obtained in Example 21, an 8-inch element was fabricated in substantially the same manner as in Example 2.

The element was placed in a pressure vessel, and operation was performed under the foregoing conditions. The amount of water production and the demineralization rate were 29.8 m³/day and 99.0%, the stability A was 99% or greater, the stability B was 94.5%, and the progress degree of fouling was 41.7%.

### Example 23

A separation membrane roll was fabricated in substantially the same manner in all respects as in Example 15, except that supply-side channel members were disposed in a grid shape in which the angle formed by two supply-side channel members 4 adjacent in the flowing direction of the supplied water was 45° so that the channel members, with the height h=0.83 mm, the width d=0.83 mm, and the pitch in the length direction being 1.6 mm, were fixed to the supply-side surface of the separation membrane.

A portion of 43 cm² of the separation membrane in which dots were disposed was cut out, and placed in a pressure vessel, and operation was performed under the foregoing conditions. The amount of water production and the demineralization rate were 1.03 m³/m²/day and 98.6%.

### Example 24

Using the separation membrane roll obtained in Example 23, an 8-inch element was fabricated in substantially the same manner as in Example 2.

The element was placed in a pressure vessel, and operation was performed under the foregoing conditions. The amount of water production and the demineralization rate were 31.7 m³/day and 98.3%, the stability A was 99% or greater, the stability B was 95.7%, and the progress degree of fouling was 38.9%.

### Example 25

A separation membrane roll was fabricated in substantially the same manner in all respects as in Example 15, except that on both side end portions on the supply side of the separation membrane main body, band-shaped regions of 40 mm in width made up of stripe-shaped second supply-side channel members 42 (a linear rectangular parallelepiped shape inclined at 45° relative to the x-axis direction, 0.415 mm in height, and 1 mm in width) were provided. The dots were provided on only one of the supply-side surfaces that faced each other when incorporated in an element, and the band-shaped regions were provided on both of the supply-side surfaces that faced each other.

After that, an 8-inch element was fabricated in substantially the same manner as in Example 2.

The element was placed in a pressure vessel, and operation was performed under the foregoing conditions. The amount of water production and the demineralization rate were 30.6 m³/day and 99.0%, the stability A was 99% or greater, the stability B was 95.7%, and the progress degree of fouling was 42.3%.

### Example 26

A separation membrane roll was fabricated in substantially the same manner as in Example 15, except that as filtrate-side channel members, filtrate-side channel members were fixed instead of the tricot. As for the filtrate-side channel members, using on the filtrate-side surface of the separation membrane an applicator loaded with a comb shim whose slit width was 0.5 mm and whose pitch in the length direction was 1.0 mm, an ethylene vinyl acetate copolymer resin (trade name: 701A) was applied at a resin temperature of 130° C. and a running speed of 5.5 m/min, linearly so that when a separation membrane element was made, the direction of the applied resin was perpendicular to the lengthwise direction of the water collecting pipe, and so that when an envelope-shaped membrane was made, the direction of the applied resin, from the end portion inside with respect to the winding direction to the end portion outside with respect to the winding direction, was perpendicular to the lengthwise direction of the water collecting pipe, and while the temperature of the backup roll was adjusted to 20° C. Thus, the filtrate-side channel members, with the height of the filtrate-side channel members being 0.3 mm, and the width of the channel members being 0.9 mm, the interval of the channel members in the lengthwise direction of the water collecting pipe being 0.5 mm, and the pitch thereof being 1.0 mm, were fixed to the entire separation membrane.

Using the separation membrane roll obtained in this manner, an 8-inch element was fabricated in substantially the same manner as in Example 2.

The element was placed in a pressure vessel, and operation was performed under the foregoing conditions. The amount of water production and the demineralization rate were 36.0 m³/day and 98.5%, the stability A was 99% or greater, the stability B was 95.7%, and the progress degree of fouling was 39.0%.

### Example 27

A separation membrane roll was fabricated in substantially the same manner in all respects as in Example 26, except that on both side end portions on the supply side of the separation membrane main body, band-shaped regions of 40 mm in width were provided. The dots were provided on only one of the supply-side surfaces that faced each other when incorporated in an element, and the band-shaped regions were provided on both of the supply-side surfaces that faced each other.

After that, an 8-inch element was fabricated in substantially the same manner as in Example 2.

The element was placed in a pressure vessel, and operation was performed under the foregoing conditions. The amount of water production and the demineralization rate were 34.9 m³/day and 98.8%, the stability A was 99% or greater, the stability B was 95.7%, and the progress degree of fouling was 38.8%.

### Example 28

A separation membrane roll was fabricated in substantially the same manner in all respects as in Example 1, except that the base material was changed to a long-fiber nonwoven fabric. The fiber orientation degree of the base material was 20° in a porous support layer-side surface layer and 40° in the surface layer opposite to the porous support layer. The dot-shaped supply-side channel members were provided on only one of the supply-side surfaces that faced each other when incorporated in an element.

Using the separation membrane roll obtained in this manner, an 8-inch element was fabricated in substantially the same manner as in Example 2.

The element was placed in a pressure vessel, and operation was performed under the foregoing conditions. The amount of water production and the demineralization rate were 31.5 m³/day and 98.7%, the stability A was 99% or greater, the stability B was 95.8%, and the progress degree of fouling was 38.8%.

### Example 29

A separation membrane roll was fabricated in substantially the same manner in all respects as in Example 15, except that the angle formed by two supply-side channel members 4 adjacent in the flowing direction of the supplied water was changed to 45° and the pitch was changed to 1.6 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.6 m³/day and 98.0%, the stability A was 99% or greater, the stability B was 95.7%, and the progress degree of fouling was 39.0%.

### Example 30

A separation membrane roll was fabricated in substantially the same manner in all respects as in Example 15, except that the angle formed by two supply-side channel members 4 adjacent in the flowing direction of the supplied water was changed to 10° and the pitch was changed to 2.6 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.3 m³/day and 97.6%, the stability A was 99% or greater, the stability B was 95.7%, and the progress degree of fouling was 42.8%.

### Example 31

A separation membrane roll was fabricated in substantially the same manner in all respects as in Example 15, except that the angle formed by two supply-side channel members 4 adjacent in the flowing direction of the supplied water was changed to 170° and the pitch was changed to 1.5 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 30.6 m³/day and 97.7%, the stability A was 99% or greater, the stability B was 95.8%, and the progress degree of fouling was 43.0%.

### Example 32

A separation membrane roll was fabricated by injection-molding on a biaxial drawing polyester film (Lumirror S Type 50 μm made by Toray) a net in which the width of fiber is 0.5 mm and the intersection point height was 0.83 mm, and the supply-side channel member was transferred to the separation membrane supply side at 120° C.

Using the separation membrane roll, an 8-inch element was fabricated in substantially the same manner as in Example 2.

The element was placed in a pressure vessel, and operation was performed under the foregoing conditions. The amount of water production and the demineralization rate were 28.9 m³/day and 99.0%, the stability A was 99% or greater, the stability B was 94.0%, and the progress degree of fouling was 53.0%.

### Comparative Example 1

A separation membrane roll was fabricated in substantially the same manner in all respects as in Example 1, except that discontinuous channel members based on the disclosure were not disposed on the supply side, but a net (Thickness: 0.83 mm. Pitch: 4 mm×4 mm. Fiber diameter: 415 μm. Projected area ratio: 0.20.) was used.

The element was placed in a pressure vessel, and operation was performed under the foregoing conditions. The amount of water production and the demineralization rate were 28.8 m³/day and 99.0%, the stability A was 99.5% or greater, the stability B was 99.4%, and the progress degree of fouling was 53.1%.

### Comparative Example 2

A separation membrane roll was fabricated in substantially the same manner in all respects as in Example 1, except that the resin used for supply-side channel members was an ethylene vinyl acetate copolymer resin (trade name: 701A), and the resin was applied in a dot shape at a resin temperature of 110° C. and a running speed of 3.0 m/min so that channel members, with the height h=0.20 mm, the width d=0.35 mm, and the pitch in the length direction of the separation membrane being 1.8 mm, were fixed to the separation membrane's supply-side surface.

Using the separation membrane roll obtained in this manner, an 8-inch element was fabricated in substantially the same manner as in Example 2.

The element was placed in a pressure vessel, and operation was performed under the foregoing conditions. The amount of water production and the demineralization rate was 30.4 m³/day and 98.0,%. The stability A was 87%, the stability B was 69%, and the progress degree of fouling was 46.5%.

### Comparative Example 3

A separation membrane roll was fabricated in substantially the same manner in all respects as in Example 1, except that the resin used for channel members was an ethylene vinyl acetate copolymer resin (trade name: 701A) and the resin was applied in a dot shape at a resin temperature of 110° C. and a running speed of 3.0 m/min so that channel members, with the height h=0.83 mm, the width d=2 mm, and the pitch in the length direction of the separation membrane being 6.7 mm, were fixed to the separation membrane's supply-side surface.

Using the separation membrane roll obtained in this manner, an 8-inch element was fabricated in substantially the same manner as in Example 2.

The element was placed in a pressure vessel, and operation was performed under the foregoing conditions. The amount of water production and the demineralization rate were 30.0 m³/day and 97.9%, the stability A was 65%, and the progress degree of fouling was 45.0%.

### Comparative Example 4

A separation membrane roll was fabricated in substantially the same manner in all respects as in Comparative Example 3, except that the angle formed by two supply-side channel members 4 adjacent in the flowing direction of the supplied water was changed to 10° and the pitch was changed to 2.6 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 29.0 m³/day and 96.8%, the stability A was 65%, and the progress degree of fouling was 45.6%.

### Comparative Example 5

A separation membrane roll was fabricated in substantially the same manner in all respects as in Comparative Example 3, except that the angle formed by two supply-side channel members 4 adjacent in the flowing direction of the supplied water was changed to 170°, and the pitch was changed to 1.5 mm.

Using the separation membrane roll, an 8-inch element was fabricated in substantially the same manner as in Example 2.

The element was placed in a pressure vessel, and operation was performed under the foregoing conditions. The amount of water production and the demineralization rate were 29.6 m³/day and 97.0%, the stability A was 67%, and progress degree of fouling was 47.6%.

As is apparent from results, the separation membrane of the examples have high water production performance, safe operation performance, and excellent removal performance.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Nonwoven fabric | | | Paper | Paper | Paper | Paper | Paper | Paper | Paper |
| Supply-side | — | Height h (mm) | 0.83 | 0.83 | 0.83 | 0.83 | 0.83 | 0.83 | 0.83 |
| channel member | | Width d (mm) | 0.52 | 0.52 | 0.52 | 0.52 | 0.52 | 0.30 | 1.20 |
| | | Ratio of height/width h/d | 1.6 | 1.6 | 1.6 | 1.6 | 1.6 | 2.8 | 0.7 |
| | | Porosity (%) | 80 | 80 | 50 | 5 | 88 | 80 | 80 |
| | | Aspect ratio | 1.0 | 1.0 | 1.0 | 1.0 | 1.0 | 1.0 | 1.0 |
| | | Pitch in separation | 1.8 | 1.8 | 1.8 | 1.8 | 1.8 | 1.0 | 2.7 |
| | | membrane length direction | | | | | | | |
| | | (mm) | | | | | | | |
| | | Formed angle (°) | 90 | 90 | 90 | 90 | 90 | 90 | 90 |
| | Band- | Disposition form | — | — | — | — | — | — | — |
| | shaped | Disposed position | — | — | — | — | — | — | — |
| | regions | Applied width (mm, water | — | — | — | — | — | — | — |
| | of end | collecting pipe lengthwise | | | | | | | |
| | portions | direction) | | | | | | | |
| | | Elevation difference (mm) | — | — | — | — | — | — | — |
| | | Line width (mm) | — | — | — | — | — | — | — |
| | | Pitch (mm) | — | — | — | — | — | — | — |

| | | | | | | | | |
|---|---|---|---|---|---|---|---|---|
| Separation membrane's | Water production amount | 1.02 | — | — | — | — | — | — |
| performance | (m3/m2/day) | | | | | | | |
| | Demineralization rate | 98.7 | — | — | — | — | — | — |
| | (%) | | | | | | | |
| Element's performance | Water production amount | — | 31.2 | 31.0 | 31.0 | 31.1 | 31.6 | 30.1 |
| | (m3/day) | | | | | | | |
| | Demineralization rate (%) | — | 98.8 | 98.8 | 98.8 | 98.8 | 99.0 | 98.5 |
| | Stability A (%) | — | 99.5 or | 99.5 or | 99.5 or | 99.5 or | 99.5 or | 99.5 or |
| | | | greater | greater | greater | greater | greater | greater |
| | Stability B (%) | — | 99.5 | 98.2 | 96.2 | 99.6 | 99.6 | 99.2 |
| | Progress degree of fouling | — | 39.0 | 39.0 | 38.9 | 39.1 | 36.0 | 42.2 |
| | (%) | | | | | | | |

TABLE 2

| | | | Example | Example | Example | Example | Example | Example | Example |
|---|---|---|---|---|---|---|---|---|---|
| | | | 8 | 9 | 10 | 11 | 12 | 13 | 14 |
| Nonwoven fabric | | | Paper | Paper | Paper | Paper | Paper | Paper | Paper |
| Supply-side | — | Height h (mm) | 0.83 | 0.83 | 0.83 | 0.83 | 0.83 | 0.83 | 0.83 |
| channel member | | Width d (mm) | 0.52 | 0.52 | 0.52 | 0.52 | 0.52 | 0.52 | 0.52 |
| | | Ratio of height/width h/d | 1.6 | 1.6 | 1.6 | 1.6 | 1.6 | 1.6 | 1.6 |
| | | Porosity (%) | 80 | 80 | 80 | 80 | 80 | 80 | 80 |
| | | Aspect ratio | 1.0 | 1.0 | 1.0 | 1.0 | 1.0 | 1.0 | 1.0 |
| | | Pitch in separation | 5.6 | 1.6 | 1.4 | 1.4 | 1.4 | 1.4 | 1.4 |
| | | membrane length direction | | | | | | | |
| | | (mm) | | | | | | | |
| | | Formed angle (°) | 30 | 45 | 150 | 90 | 90 | 90 | 90 |
| | Band- | Disposition form | — | — | — | Stripe | — | Stripe | — |
| | shaped | Disposed position | — | — | — | Both | — | Both | — |
| | regions | | | | | side end | | side end | |
| | of end | | | | | portions | | portions | |
| | portions | Applied width (mm, water | — | — | — | 80 (40 × | — | 80 (40 × | — |
| | | collecting pipe lengthwise | | | | 2) | | 2) | |
| | | direction) | | | | | | | |
| | | Elevation difference (mm) | — | — | — | 0.83 (0.415 × | — | 0.83 (0.415 × | — |
| | | | | | | 2) | | 2) | |
| | | Inclined angle (°) | — | — | — | 45 | — | 45 | — |
| | | Line width (mm) | — | — | — | 1 | — | 1 | — |
| | | Pitch (mm) | — | — | — | 2 × 3 | — | 2 × 3 | — |

| | | | | | | | | |
|---|---|---|---|---|---|---|---|---|
| Element's performance | Water production amount | 30.5 | 30.0 | 30.3 | 30.5 | 35.7 | 35.0 | 31.2 |
| | (m3/day) | | | | | | | |
| | Demineralization rate (%) | 98.5 | 98.6 | 98.5 | 99.0 | 98.5 | 98.7 | 98.8 |
| | Stability A (%) | 99.5 or | 99.5 or | 99.5 or | 99.5 or | 99.5 or | 99.5 or | 99.5 or |
| | | greater | greater | greater | greater | greater | greater | greater |
| | Stability B (%) | 99.5 | 99.5 | 99.5 | 99.5 | 99.5 | 99.5 | 99.7 |
| | Progress degree of fouling | 42.5 | 41.0 | 42.4 | 41.5 | 40.0 | 42.2 | 39.0 |
| | (%) | | | | | | | |

TABLE 3

| | | | Example | Example | Example | Example | Example | Example | Example |
|---|---|---|---|---|---|---|---|---|---|
| | | | 15 | 16 | 17 | 18 | 19 | 20 | 21 |
| Nonwoven fabric | | | Paper | Paper | Paper | Paper | Paper | Paper | Paper |
| Supply-side | — | Height h (mm) | 0.83 | 0.83 | 0.83 | 0.83 | 0.83 | 0.83 | 0.83 |
| channel member | | Width d (mm) | 0.52 | 0.52 | 0.30 | 0.30 | 0.70 | 0.70 | 0.83 |
| | | Ratio of height/width h/d | 1.6 | 1.6 | 2.8 | 2.8 | 1.2 | 1.2 | 1.0 |
| | | Aspect ratio | 1.0 | 1.0 | 1.0 | 1.0 | 1.0 | 1.0 | 1.0 |
| | | Pitch in separation | 1.8 | 1.8 | 1.0 | 1.0 | 2.3 | 2.3 | 2.8 |
| | | membrane length direction | | | | | | | |
| | | (mm) | | | | | | | |
| | | Formed angle (°) | 90 | 90 | 90 | 90 | 90 | 90 | 90 |
| | Band- | Disposition form | — | — | — | — | — | — | — |
| | shaped | Disposed position | — | — | — | — | — | — | — |
| | regions | Applied width (mm, water | — | — | — | — | — | — | — |
| | of end | collecting pipe lengthwise | | | | | | | |
| | portions | direction) | | | | | | | |
| | | Elevation difference (mm) | — | — | — | — | — | — | — |
| | | Line width (mm) | — | — | — | — | — | — | — |
| | | Pitch (mm) | — | — | — | — | — | — | — |

| | | | | | | | | |
|---|---|---|---|---|---|---|---|---|
| Separation membrane's | Water production amount | 1.02 | — | 1.03 | — | 1.03 | — | 1.02 |
| performance | (m3/m2/day) | | | | | | | |
| | Demineralization rate (%) | 98.6 | — | 98.6 | — | 98.2 | — | 98.6 |
| Element's performance | Water production amount | — | 31.3 | — | 32.0 | — | 30.5 | — |
| | (m3/day) | | | | | | | |
| | Demineralization rate (%) | — | 98.7 | — | 98.3 | — | 98.8 | — |
| | Stability A (%) | — | 99 or | — | 99 or | — | 99 or | — |
| | | | greater | | greater | | greater | |
| | Stability B (%) | — | 95.8 | — | 95.0 | — | 95.6 | — |
| | Progress degree of fouling | — | 38.8 | — | 35.9 | — | 41.0 | — |
| | (%) | | | | | | | |

TABLE 4

| | | | Example | Example | Example | Example | Example | Example | Example |
|---|---|---|---|---|---|---|---|---|---|
| | | | 22 | 23 | 24 | 25 | 26 | 27 | 28 |
| Nonwoven fabric | | | Paper | Paper | Paper | Paper | Paper | Paper | Long |
| | | | | | | | | | fiber |
| Supply-side | — | Height h (mm) | 0.83 | 0.83 | 0.83 | 0.83 | 0.83 | 0.83 | 0.83 |
| channel member | | Width d (mm) | 0.83 | 0.83 | 0.83 | 0.50 | 0.52 | 0.52 | 0.52 |
| | | Ratio of height/width h/d | 1.0 | 1.0 | 1.0 | 1.6 | 1.6 | 1.6 | 1.6 |
| | | Aspect ratio | 1.0 | 1.0 | 1.0 | 1.0 | 1.0 | 1.0 | 1.0 |
| | | Pitch in separation | 2.8 | 1.6 | 1.6 | 1.8 | 1.8 | 1.8 | 1.8 |
| | | membrane length direction | | | | | | | |
| | | (mm) | | | | | | | |
| | | Formed angle (°) | 90 | 45 | 90 | 90 | 90 | 90 | 90 |
| | Band- | Disposition form | — | — | — | Stripe | — | Stripe | — |
| | shaped | Disposed position | — | — | — | Both | — | Both | — |
| | regions | | | | | side end | | side end | |
| | of end | | | | | portions | | portions | |
| | portions | Applied width (mm, water | — | — | — | 80 (40 × | — | 80 (40 × | — |
| | | collecting pipe lengthwise | | | | 2) | | 2) | |
| | | direction) | | | | | | | |
| | | Elevation difference (mm) | — | — | — | 0.83 (0.415 × | — | 0.83 (0.415 × | — |
| | | | | | | 2) | | 2) | |
| | | Inclined angle (°) | — | — | — | 45 | — | 45 | — |
| | | Line width (mm) | — | — | — | 1 | — | 1 | — |
| | | Pitch (mm) | — | — | — | 2 × 3 | — | 2 × 3 | — |

| | | | | | | | | |
|---|---|---|---|---|---|---|---|---|
| Separation membrane's | Water production amount | — | 1.03 | — | — | — | — | — |
| performance | (m3/m2/day) | | | | | | | |
| | Demineralization rate (%) | — | 98.6 | — | — | — | — | — |
| Element's performance | Water production amount | 29.8 | — | 31.7 | 30.6 | 36.0 | 34.9 | 31.5 |
| | (m3/day) | | | | | | | |
| | Demineralization rate (%) | 99.0 | — | 98.3 | 99.0 | 98.5 | 98.8 | 98.7 |
| | Stability A (%) | 99 or | — | 99 or | 99 or | 99 or | 99 or | 99 or |
| | | greater | | greater | greater | greater | greater | greater |
| | Stability B (%) | 94.5 | — | 95.7 | 95.7 | 95.7 | 95.7 | 95.8 |
| | Progress degree of fouling | 41.7 | — | 38.9 | 42.3 | 39.0 | 38.8 | 38.8 |
| | (%) | | | | | | | |

TABLE 5

| | | | Example | Example | Example | Example |
|---|---|---|---|---|---|---|
| | | | 29 | 30 | 31 | 32 |
| Nonwoven fabric | | | Paper | Paper | Paper | Paper |
| Supply-side | — | Height h (mm) | 0.83 | 0.83 | 0.83 | 0.83 |
| channel member | | Width d (mm) | 0.52 | 0.52 | 0.52 | 0.52 |
| | | Ratio of height/width h/d | 1.6 | 1.6 | 1.6 | 1.6 |
| | | Aspect ratio | 1.0 | 1.0 | 1.0 | 1.0 |
| | | Pitch in separation membrane | 1.6 | 2.6 | 1.5 | 1.8 |
| | | length direction (mm) | | | | |
| | | Formed angle (°) | 45 | 10 | 170 | 170 |

| | | | | | |
|---|---|---|---|---|---|
| Element's performance | Water production amount | 30.6 | 30.3 | 30.6 | 28.9 |
| | (m3/day) | | | | |
| | Demineralization rate (%) | 98.0 | 97.6 | 97.7 | 99.0 |
| | Stability A (%) | 99 or | 99 or | 99 or | 99 or |
| | | greater | greater | greater | greater |
| | Stability B (%) | 95.7 | 95.7 | 96 | 94.0 |
| | Progress degree of fouling | 39.0 | 42.8 | 43.0 | 53.0 |
| | (%) | | | | |

TABLE 6

| | | | Comparative | Comparative | Comparative | Comparative | Comparative |
|---|---|---|---|---|---|---|---|
| | | | Example 1 | Example 2 | Example 3 | Example 4 | Example 5 |
| Nonwoven fabric | | | Paper | Paper | Paper | Paper | Paper |
| Supply-side | — | Height h (mm) | — | 0.20 | 0.83 | 0.83 | 0.83 |
| channel member | | Width d (mm) | — | 0.35 | 2.00 | 2.00 | 2.00 |
| | | Ratio of height/width h/d | — | 0.57 | 0.42 | 0.42 | 0.42 |
| | | Aspect ratio | — | 1.0 | 1.0 | 1.0 | 1.0 |
| | | Pitch in separation membrane | — | 1.8 | 6.7 | 2.6 | 1.5 |
| | | length direction (mm) | | | | | |
| | | Formed angle (°) | — | 90 | 90 | 10 | 170 |

| | | | | | | |
|---|---|---|---|---|---|---|
| Element's performance | Water production amount | 28.8 | 30.4 | 30.0 | 29.0 | 29.6 |
| | (m3/day) | | | | | |
| | Demineralization rate (%) | 99.0 | 98.0 | 97.9 | 96.8 | 97.0 |
| | Stability A (%) | 99.5 or | 87 | 65 | 65 | 67 |
| | | greater | | | | |
| | Stability B (%) | 99.4 | 69.0 | — | — | — |
| | Progress degree of fouling | 53.1 | 46.5 | 45.0 | 45.6 | 47.6 |
| | (%) | | | | | |

### INDUSTRIAL APPLICABILITY

The membrane element is capable of being used particularly suitably for demineralization of saline water and seawater.

1. A separation membrane comprising: a separation membrane main body that includes a supply-side surface and a filtrate-side surface; and a supply-side channel member disposed on the supply-side surface of the separation membrane main body,
wherein when a thickness of the supply-side channel member in a direction perpendicular to a flowing direction of a supplied water that flows on the supply-side surface is a width of the supply-side channel member, a ratio of height/width of the supply-side channel member is 0.7 or greater and 3.0 or less.

2. The separation membrane according to claim 1, wherein:
a plurality of the supply-side channel members are fixed to the supply-side surface of one separation membrane main body; and
the plurality of supply-side channel members are disposed at an interval in at least one of a longitudinal direction (MD) and a width direction (CD) of the separation membrane main body.

3. The separation membrane according to claim 1, wherein a porosity of the supply-side channel member is 5% or greater and 95% or less.

4. The separation membrane according to claim 1, wherein angle between the supply-side channel members adjacent to each other is 20 to 160°.

5. The separation membrane according to claim 1, wherein a filtrate-side channel member is fixed to the filtrate-side surface.

6. The separation membrane according to claim 1, comprising a band-shaped region in which a second supply-side channel member is disposed, on at least one of end portions of the supply-side surface in a width direction.

7. An separation membrane element characterized by comprising a water collecting pipe, and the separation membrane according to claim 1 which is rolled around a perimeter of the water collecting pipe.

8. The separation membrane according to claim 2, wherein a porosity of the supply-side channel member is 5% or greater and 95% or less.

9. The separation membrane according to claim 2, wherein angle between the supply-side channel members adjacent to each other is 20 to 160°.

10. The separation membrane according to claim 3, wherein angle between the supply-side channel members adjacent to each other is 20 to 160°.

11. The separation membrane according to claim 2, wherein a filtrate-side channel member is fixed to the filtrate-side surface.

12. The separation membrane according to claim 3, wherein a filtrate-side channel member is fixed to the filtrate-side surface.

13. The separation membrane according to claim 4, wherein a filtrate-side channel member is fixed to the filtrate-side surface.

14. The separation membrane according to claim 2, comprising a band-shaped region in which a second supply-side channel member is disposed, on at least one of end portions of the supply-side surface in a width direction.

15. The separation membrane according to claim 3, comprising a band-shaped region in which a second supply-side channel member is disposed, on at least one of end portions of the supply-side surface in a width direction.

16. The separation membrane according to claim 4, comprising a band-shaped region in which a second supply-side channel member is disposed, on at least one of end portions of the supply-side surface in a width direction.

17. The separation membrane according to claim 5, comprising a band-shaped region in which a second supply-side channel member is disposed, on at least one of end portions of the supply-side surface in a width direction.

18. An separation membrane element characterized by comprising a water collecting pipe, and the separation membrane according to claim 2 which is rolled around a perimeter of the water collecting pipe.

19. An separation membrane element characterized by comprising a water collecting pipe, and the separation membrane according to claim 3 which is rolled around a perimeter of the water collecting pipe.

20. An separation membrane element characterized by comprising a water collecting pipe, and the separation membrane according to claim 4 which is rolled around a perimeter of the water collecting pipe.
